(19) United States
(12) Patent Application Publication
(10) Pub. No.: US 2025/0207212 A1
(43) Pub. Date: Jun. 26, 2025

(54) Solid State Quenching of Metal

(71) Applicant: Hardwire, LLC, Pocomoke City, MD (US)

(72) Inventors: George C. TUNIS III, Ocean City, MD (US); Emily TUNIS, Ocean City, MD (US); Steven J. WINCKLER, Middle Grove, NY (US); Scott KENDALL, Berlin, MD (US); Justin GORDON, Snow Hill, MD (US); Brendan FOGARTY, Ocean Pines, MD (US); Alex MILLAR, West Chicago, IL (US); Ben KREMER, Snow Hill, MD (US); Jonathon MONTINI, Ocean Pines, MD (US)

(21) Appl. No.: 18/628,358

(22) Filed: Apr. 5, 2024

Related U.S. Application Data
(60) Provisional application No. 63/614,314, filed on Dec. 22, 2023.

(51) Int. Cl. C21D 1/673; B23K 26/38; C21D 1/18; C22F 1/00

(52) U.S. Cl. CPC C21D 1/673; B23K 26/38; C21D 1/18; C22F 1/002

(57) ABSTRACT

Provided herein are methods for solid state quenching of metal including transferring a heated metal workpiece having an initial workpiece temperature to a press, the press including a first die having an initial first die temperature, the initial first die temperature being lower than the initial workpiece temperature and a second die positioned opposite the first die and having an initial second die temperature, the initial second die temperature being lower than the initial workpiece temperature, wherein the first and second dies are each constructed of a material having a thermal conductivity equal to or greater than 90 W/mK at a temperature of 70 F, closing the press to bring the first die and the second die into pressurized contact with the heated metal workpiece, continuing the pressurized contact between the first and second dies and the metal workpiece to cool the metal workpiece from the initial workpiece temperature to a quenched workpiece temperature, opening the press when the metal workpiece reaches the quenched workpiece temperature to produce a quenched metal workpiece; and removing the quenched metal workpiece from the press.

### CROSS REFERENCE TO RELATED APPLICATIONS

This application claims benefit under 35 U.S.C. § 119 (e) of U.S. Provisional Application No. 63/614,314, filed on 22 Dec. 2023, entitled “Solid State Quenching of Metal,” the entirety of which is incorporated by reference herein.

### BACKGROUND

In manufacturing metal articles such as sheets, plates, formed articles and/or panels, and sheet-like and/or plate-like articles (e.g., sheet-like or plate-like armor articles and/or panels such as vehicle panels), controlling the shape of even the seemingly simplest form of metal article, flat, remains among the most difficult metal articles to produce. In general, the industry struggles to achieve acceptable flatness during processing due to thermal stresses caused, for example, by unacceptably slow and/or uneven cooling.

For example, in many military steel armor requirements, including MIL_DTL_46186B and/or MIL-DTL-32332A, the steel plate is required to have a hardness level of 530 Brinell or 570 Brinell (or higher) at thicknesses of ¼″ and thicker. Such hardness is not possible in a hot-stamping process using steel tooling to form and cool the plate; for steel ¼″ and thicker. The quench is just not fast enough.

Accordingly, the industry has resorted to hot stamping to form such metal articles, followed by complex and costly post forming heat-treatment and quenching, using a liquid quenching means with water, oil, salt water, molten metals, molten salts, and/or a variety of other fluid quenchants. Toward this end, massive investments have been made to create elaborate fluid bath, spring, and/or spray devices using fluids such as water, oil, salt water, molten metals, molten salts, and/or a variety of other fluid quenchants. Some investments have even been made in vertical quench lines in attempts to keep water or oil from pooling during quench.

However, despite such investments, regardless of the fluid used, various unpredictable and uncontrollable effects are introduced to the quenching process when fluid is deposited or otherwise brought into contact with a hot metal plate (e.g., 1600 deg. F or more for some metals such as steel). Such effects are aptly defined as uncontrolled chaos and can include violent phase changes, the development of turbulent boundary layers (which block new cooling flow by trapping heat, and real time warping due to uneven cooling that can further affect cooling water or oil flow paths.

As such, although water quenching metal articles (e.g., alloy steels) can offer rapid cooling rates and increased hardness, it comes with several disadvantages, especially when considering downstream manufacturing processes like welding and forming. Such disadvantages can include, but are not limited to, the following:

### Quench Cracking:

Water quenching involves a very high cooling rate, which can lead to thermal stresses within the metal articles, potentially causing quench cracking. This is a significant concern as it may compromise the integrity of the material.

### Increased Susceptibility to Hydrogen Embrittlement:

Water quenching can introduce hydrogen into the metal articles, especially if the process is not adequately controlled. In particular, hydrogen is introduced into the steel or metal by making water available at microcracks in the surface and at edges. While this water can sometimes harmlessly evaporate during subsequent heating, it can also become entrapped atomically, causing hydrogen embrittlement. Hydrogen embrittlement makes the metal articles more susceptible to cracking during subsequent processes like welding that stress the material such that, when the material is stressed, the hydrogen exacerbates the cracking.

### Formation of Residual Stresses:

Water quenching may result in non-uniform cooling across the metal articles, leading to the formation of residual stresses. These residual stresses can affect the material's mechanical properties and may contribute to cracking during subsequent manufacturing steps.

### Weldability Issues:

Water quenching tends to produce a hardened microstructure in the metal articles. While this contributes to increased hardness, it can also make the material less weldable. Welding hardened metal articles can result in a heat-affected zone with altered mechanical properties and an increased risk of cracking.

### Formability Challenges:

The high hardness achieved through water quenching can make the metal articles less ductile and more challenging to form. This can lead to issues during subsequent forming processes, such as bending or stamping, including irreversible cracking.

Surface Hardness Vs. Core Toughness Trade-Off:

Water quenching tends to produce a harder surface layer. While this is desirable for certain applications, it may create a trade-off with core toughness. In such cases, the material becomes more brittle at the surface, impacting its performance in dynamic or impact-loading scenarios.

### Material Distortion:

The rapid and uneven cooling associated with water quenching can result in distortion of the metal articles' shape. This distortion may complicate downstream manufacturing processes that require precise dimensions.

### Disadvantages to Forming High Hardness Quenched and Tempered (Q&T) Alloys Using Traditional Methods:

Working with high hardness quenched and tempered metal articles presents unique challenges for forming processes, including brake press operations, which is how most armor is formed today when it is not used simply as a plate. Some of the limitations and considerations associated with using traditional methods for forming high hardness quench and tempered metal articles include:

### Material Hardness:

High hardness achieved via traditional liquid quenching and tempering makes metal articles produced in this manner inherently resistant to deformation. Accordingly, excessive force or selective thermal heating may be required during forming, leading to increased wear on tools and equipment and dangerous work environments for operators.

### Tool Wear and Maintenance:

Forming processes, especially those involving high-strength metal articles, can accelerate wear and tear on tools. Thus, frequent maintenance and tool replacement is necessary to ensure consistent and quality forming.

### Springback:

High-strength metal articles, including quenched and tempered varieties, are prone to significant springback after forming. Thus, accurate prediction and compensation for springback become crucial to achieve a desired final shape. However, such predictions are notoriously difficult to perform with a high degree of reliable accuracy, resulting in a high out-of-tolerance scrap rate.

### Cracking and Fracture:

The risk of cracking and fracture increases with high-strength materials, particularly in areas with complex geometries or tight bends.

### Press Capacity:

Brake presses and other forming equipment must have adequate capacity to handle the high forces required for shaping high hardness quenched and tempered metal articles, thus increasing both the cost of equipment and, in many instances, the frequency with which such equipment must be replaced. In short, making expensive upgrades to equipment is often necessary to ensure that it meets the specific demands of such Q&T materials. Furthermore, even after such upgrades, additional finishing processes and/or precision machining may be needed to meet quality standards.

### Tooling Design:

Customized tooling with appropriate coatings or surface treatments is typically required to withstand the abrasive nature of high-strength metal articles.

Due to these challenges, the manufacturing of flat metal articles remains a slow, expensive process wherein a high percentage of output fails to meet metallurgical and/or shape requirements. Similar challenges are also experienced when attempting to control the shape of a three-dimensionally shaped/formed metal article. In both instances, expensive equipment, high levels of wear and tear, laborious and complicated processes, and high scrap rates are common, leading to slow, limited production and high costs.

These challenges can be especially problematic in the context of steel armor, which is traditionally produced using liquid quenchants such as water or oil in either baths or applied vis sprays. The rate of cooling in this process is challenging to control due to the turbulence created when the hot steel interacts with the quenching media, and while it provides an adequate quench rate, the components being quenched can distort or crack, especially in the grades of steel representing the most advanced armors which require very high hardness and toughness.

### SUMMARY

Provided herein are methods and systems for solid state quenching (SSQ) of metal. The term “Solid State Quench” is used herein to describe a quenching process that uses primarily contact cooling where the cool element/medium is a solid, as opposed to the typical wet quench using water or other liquid.

In one aspect, a method for solid state quenching (SSQ) of metal is provided. The method for SSQ includes transferring a heated metal workpiece having an initial workpiece temperature to a press. The press includes a first die having an initial first die temperature, the initial first die temperature being lower than the initial workpiece temperature. The press also includes a second die positioned opposite the first die and having an initial second die temperature, the initial second die temperature being lower than the initial workpiece temperature. The press also includes wherein the first and second dies are each constructed of a material having a thermal conductivity equal to or greater than 90 W/mK at a temperature of 70 F. The method for SSQ also includes closing the press to bring the first die and the second die into pressurized contact with the heated metal workpiece. The method for SSQ also includes continuing the pressurized contact between the first and second dies and the metal workpiece to cool the metal workpiece from the initial workpiece temperature to a quenched workpiece temperature. The method for SSQ also includes opening the press when the metal workpiece reaches the quenched workpiece temperature to produce a quenched metal workpiece. The method for SSQ also includes removing the quenched metal workpiece from the press.

In some embodiments, the method for SSQ also includes cooling the quenched metal workpiece to a fully cooled temperature to produce a metal article. In some embodiments, the method for SSQ also includes reheating the metal article to a tempering temperature greater than the fully cooled temperature and less than the initial workpiece temperature. In some embodiments, the method for SSQ also includes maintaining the metal article at the tempering temperature for a predetermined time. In some embodiments, the method for SSQ also includes recooling the metal article to the fully cooled temperature to produce a tempered metal article. In some embodiments, the method for SSQ also includes maintaining the quenched metal workpiece at the quenched workpiece temperature for a predetermined time. In some embodiments, the method for SSQ also includes cooling the quenched metal workpiece to a fully cooled workpiece temperature to produce a metal article. In some embodiments, the step of cooling the quenched metal workpiece to a fully cooled temperature to produce a metal article further comprises autotempering the quenched metal workpiece in an ambient environment. In some embodiments, the quenched workpiece temperature is equal to a fully cooled temperature and the quenched metal workpiece is a metal article. In some embodiments, the method for SSQ also includes laser cutting the metal article to produce at least one cut edge in the metal article. In some embodiments, the method for SSQ also includes reheating the metal article to a heat-treating temperature equal to or greater than the fully cooled temperature and less than the initial workpiece temperature. In some embodiments, the method for SSQ also includes maintaining the metal article at the heat-treating temperature for a predetermined time sufficient to recrystallize at least one unwanted crystalline structure formed along the cut edge during the step of laser cutting. In some embodiments, the method for SSQ also includes recooling the metal article to the fully cooled temperature to produce a healed metal article. In some embodiments, the method for SSQ also includes transferring the reheated metal workpiece to the press. In some embodiments, the method for SSQ also includes reclosing the press to bring the first die and the second die into pressurized contact with the reheated metal article.

In some embodiments, the method for SSQ also includes creating a heat affected zone (HAZ) of the metal article by welding the metal article. In some embodiments, the method for SSQ also includes reheating the metal article to a HAZ heat-treating temperature greater than the fully cooled temperature and less than the initial workpiece temperature. In some embodiments, the method for SSQ also includes maintaining the metal article at the heat-treating temperature for a predetermined time sufficient to recrystallize at least one unwanted crystalline structure of the HAZ. In some embodiments, the method for SSQ also includes recooling the metal article to the fully cooled temperature to produce a healed metal article. In some embodiments, the method for SSQ also includes transferring the reheated metal workpiece to the press. In some embodiments, the method for SSQ also includes reclosing the press to bring the first die and the second die into pressurized contact with the reheated metal article. In some embodiments, the metal workpiece includes one or more of iron, steel, aluminum, titanium, copper, nickel tungsten, alloys thereof, and combinations thereof. In some embodiments, the first and second dies are constructed of a material having higher thermal conductivity, effusivity, and diffusivity than the metal workpiece. In some embodiments, the first and second dies are constructed of at least one of aluminum or an aluminum alloy.

In some embodiments, a shape of the heated metal workpiece is at least one of flat or three-dimensional. In some embodiments, the first and second dies are flat for producing a flat quenched metal workpiece. In some embodiments, the quenched metal workpiece is a sheet or plate. In some embodiments, the shape of the heated metal workpiece is flat and the flat shape of the first and/or second dies is complementary to the flat shape of the heated metal workpiece. In some embodiments, the shape of the heated metal workpiece is three-dimensional and the pressurized contact between the flat first and second dies and the heated metal workpiece forms the heated metal workpiece into the flat quenched metal workpiece. In some embodiments, at least one of the first and second dies has a three-dimensional mold shape for producing a three-dimensionally shaped quenched metal workpiece. In some embodiments, the shape of the heated metal workpiece is three-dimensional and the three-dimensional mold shape of the first and/or second dies is complementary to the three-dimensional shape of the heated metal workpiece. In some embodiments, the three-dimensional mold shape of the first and/or second dies is different than the shape of the heated metal workpiece and the pressurized contact between the first and second dies and the heated metal workpiece forms the heated metal workpiece into the three-dimensionally shaped quenched metal workpiece.

In some embodiments, the shape of the heated metal workpiece is three-dimensional and the method for SSQ also includes forming a metal workpiece to provide a shaped metal workpiece. In some embodiments, the shape of the heated metal workpiece is three-dimensional and the method for SSQ also includes heating the shaped metal workpiece to produce the heated metal workpiece. In some embodiments, the step of forming further comprises at least one of sheet metal braking, die forming, progressive die forming, welding, cutting, machining, 3D printing, or combinations thereof. In some embodiments, the step of heating further comprises heat-treating the metal workpiece. In some embodiments, the step of forming includes at least one of laser cutting, welding, or both. In some embodiments, the step of heat-treating includes at least one of maintaining the shaped metal workpiece at a HAZ heat-treating temperature for a predetermined time sufficient to recrystallize at least one unwanted crystalline structure of a heat affected zone (HAZ) created in the shaped metal workpiece by the welding or maintaining the shaped metal workpiece at a cut edge heat-treating temperature for a predetermined time sufficient to recrystallize at least one unwanted crystalline structure formed along a cut edge of the shaped metal workpiece during the step of laser cutting.

In some embodiments, the method for SSQ also includes cooling at least one of the first die or the second die. In some embodiments, the step of cooling at least one of the first die or the second die is performed by a liquid cooling system of the press, wherein a liquid coolant of the liquid cooling system does not contact the workpiece. In some embodiments, the method for SSQ also includes heating at least one of the first die or the second die. In some embodiments, the step of heating of at least one of the first die or the second die is performed by at least one electrical element of the press, wherein the at least one electrical element does not contact the workpiece. In some embodiments, the step of heating of at least one of the first die or the second die is performed by a liquid heating system of the press, wherein a liquid of the liquid heating system does not contact the workpiece. In some embodiments, the step of closing the press further comprises bringing at least one additional die of the press into pressurized contact with the heated metal workpiece. In some embodiments, the initial workpiece temperature exceeds a melting point of at least one of the first die or the second die. In some embodiments, the step of continuing the pressurized contact between the first and second dies and the metal workpiece includes continuing the pressurized contact at a pressure equal to or greater than 1 psi.

In another aspect, a method for hybrid quenching (HSSQ) of metal is provided. The method for HSSQ includes transferring a heated metal workpiece having a primary substrate, one or more out of plane features, and an initial workpiece temperature to a press. The press includes a first die having an initial first die temperature, the initial first die temperature being lower than the initial workpiece temperature. The press also includes a second die positioned opposite the first die and having an initial second die temperature, the initial second die temperature being lower than the initial workpiece temperature. The press also includes one or more voids defined in the first die, the second die, or both, at least one of the one or more voids corresponding to and sized to receive one of the out of plane features of the heated metal workpiece. The press also includes wherein the first and second dies are each constructed of a material having a thermal conductivity equal to or greater than 90 W/mK at a temperature of 70 F. The method for HSSQ also includes closing the press to bring the first die and the second die into pressurized contact with at least 50% of a surface area of the primary substrate of the heated metal workpiece. The method for HSSQ also includes flowing a fluid through the one or more voids to flow over the corresponding one of the out of plane features of the heated workpiece received therein. The method for HSSQ also includes continuing both the fluid flow through the one or more voids and the pressurized contact between the first and second dies and the primary substrate to cool the metal workpiece from the initial workpiece temperature to a quenched workpiece temperature. The method for HSSQ also includes terminating the fluid flow and opening the press when the metal workpiece reaches the quenched workpiece temperature to produce a quenched metal workpiece. The method for HSSQ also includes removing the quenched metal workpiece from the press.

In some embodiments, the fluid is at least one of water, oil, salt water, a molten salt, a molten metal, glycol, a dielectric fluid, or combinations thereof. In some embodiments, the press also includes a fluid input port and a fluid output port to permit flowing of the fluid through the one or more voids. In some embodiments, the first and second dies are configured to conduct heat away from both the metal workpiece and the flowing fluid. In some embodiments, the first and second dies are constructed of a material having higher thermal conductivity, effusivity, and diffusivity than the metal workpiece. In some embodiments, the first and second dies are configured to conduct sufficient heat away from the flowing fluid to prevent the flowing fluid from undergoing a phase change in the one or more voids. In some embodiments, a mass flow rate of the flowing fluid permits the flowing fluid to convect heat from the metal workpiece to the first and second dies without undergoing a phase transformation in the one or more voids.

In some embodiments, the method for HSSQ also includes cooling the quenched metal workpiece to a fully cooled temperature to produce a metal article. In some embodiments, the method for HSSQ also includes laser cutting the metal article to produce at least one cut edge in the metal article. In some embodiments, the method for HSSQ also includes reheating the metal article to a heat-treating temperature equal to or greater than the fully cooled temperature and less than the initial workpiece temperature. In some embodiments, the method for HSSQ also includes maintaining the metal article at the heat-treating temperature for a predetermined time sufficient to recrystallize at least one unwanted crystalline structure formed along the cut edge during the step of laser cutting. In some embodiments, the method for HSSQ also includes recooling the metal article to the fully cooled temperature to produce a healed metal article. In some embodiments, the method for HSSQ also includes transferring the reheated metal workpiece to the press. In some embodiments, the method for HSSQ also includes reclosing the press to bring the first die and the second die into pressurized contact with the reheated metal article. In some embodiments, the method for HSSQ also includes flowing the fluid through the one or more voids to flow over the corresponding one of the out of plane features of the reheated workpiece received therein. In some embodiments, the method for HSSQ also includes creating a heat affected zone (HAZ) of the metal article by welding the metal article. In some embodiments, the method for HSSQ also includes reheating the metal article to a HAZ heat-treating temperature greater than the fully cooled temperature and less than the initial workpiece temperature. In some embodiments, the method for HSSQ also includes maintaining the metal article at the heat-treating temperature for a predetermined time sufficient to recrystallize at least one unwanted crystalline structure of the HAZ. In some embodiments, the method for HSSQ also includes recooling the metal article to the fully cooled temperature to produce a healed metal article. In some embodiments, the method for HSSQ also includes transferring the reheated metal workpiece to the press. In some embodiments, the method for HSSQ also includes reclosing the press to bring the first die and the second die into pressurized contact with the primary substrate of the reheated metal article. In some embodiments, the method for HSSQ also includes flowing the fluid through the one or more voids to flow over the corresponding one of the out of plane features of the reheated workpiece received therein.

In a further aspect, a method for bending metal is by press braking is provided. The method for bending metal includes laser cutting a metal plate to form a protrusion alignment feature thereon at a location to be bent. The protrusion alignment feature includes a rounded protrusion extending outward from an edge of the metal plate and oriented along the edge in an out of plane direction relative to the metal plate. The protrusion alignment feature also includes first and second filleted transitions positioned along opposing sides of the rounded protrusion between the rounded protrusion and the metal plate. The protrusion alignment feature also includes bending, using a press brake, the metal plate at a location indicated by the protrusion alignment feature.

Additional features and aspects of the technology include the following:

1. A method for solid state quenching of metal comprising:
transferring a heated metal workpiece having an initial workpiece temperature to a press, the press comprising:
   a first die having an initial first die temperature, the initial first die temperature being lower than the initial workpiece temperature, and
   a second die positioned opposite the first die and having an initial second die temperature, the initial second die temperature being lower than the initial workpiece temperature,
   wherein the first and second dies are each constructed of a material having a thermal conductivity equal to or greater than 90 W/mK at a temperature of 70 F;
closing the press to bring the first die and the second die into pressurized contact with the heated metal workpiece;
continuing the pressurized contact between the first and second dies and the metal workpiece to cool the metal workpiece from the initial workpiece temperature to a quenched workpiece temperature;
opening the press when the metal workpiece reaches the quenched workpiece temperature to produce a quenched metal workpiece; and
removing the quenched metal workpiece from the press.
   2. The method of feature 1, further comprising cooling the quenched metal workpiece to a fully cooled temperature to produce a metal article.
   3 The method of any of features 1-2, further comprising reheating the metal article to a tempering temperature greater than the fully cooled temperature and less than the initial workpiece temperature.
   4. The method of feature 3, further comprising:
maintaining the metal article at the tempering temperature for a predetermined time; and
recooling the metal article to the fully cooled temperature to produce a tempered metal article.
   5. The method of any of features 1-4, further comprising:
maintaining the quenched metal workpiece at the quenched workpiece temperature for a predetermined time; and
cooling the quenched metal workpiece to a fully cooled workpiece temperature to produce a metal article.
   6. The method of any of features 2-5, wherein the step of cooling the quenched metal workpiece to a fully cooled temperature to produce a metal article further comprises autotempering the quenched metal workpiece in an ambient environment.
   7. The method of any of features 1-6, wherein the quenched workpiece temperature is equal to a fully cooled temperature and the quenched metal workpiece is a metal article.
   8. The method of any of features 2-7, further comprising laser cutting the metal article to produce at least one cut edge in the metal article.
   9. The method of feature 8, further comprising:
reheating the metal article to a heat-treating temperature equal to or greater than the fully cooled temperature and less than the initial workpiece temperature;
maintaining the metal article at the heat-treating temperature for a predetermined time sufficient to recrystallize at least one unwanted crystalline structure formed along the cut edge during the step of laser cutting; and
recooling the metal article to the fully cooled temperature to produce a healed metal article.
   10. The method of feature 9, further comprising:
transferring the reheated metal workpiece to the press; and
reclosing the press to bring the first die and the second die into pressurized contact with the reheated metal article.
   11. The method of any of features 2-10, further comprising:
creating a heat affected zone (HAZ) of the metal article by welding the metal article;
reheating the metal article to a HAZ heat-treating temperature greater than the fully cooled temperature and less than the initial workpiece temperature;
maintaining the metal article at the heat-treating temperature for a predetermined time sufficient to recrystallize at least one unwanted crystalline structure of the HAZ; and
recooling the metal article to the fully cooled temperature to produce a healed metal article.
   12. The method of feature 11, further comprising:
transferring the reheated metal workpiece to the press; and
reclosing the press to bring the first die and the second die into pressurized contact with the reheated metal article.
   13. The method of any of features 1-12, wherein the metal workpiece includes one or more of iron, steel, aluminum, titanium, copper, nickel tungsten, alloys thereof, and combinations thereof.
   14. The method of any of features 1-13, wherein the first and second dies are constructed of a material having higher thermal conductivity, effusivity, and diffusivity than the metal workpiece.
   15. The method of any of features 1-14, wherein the first and second dies are constructed of at least one of aluminum or an aluminum alloy.
   16. The method of any of features 1-15, wherein a shape of the heated metal workpiece is at least one of flat or three-dimensional.
   17. The method of feature 16, wherein the first and second dies are flat for producing a flat quenched metal workpiece.
   18. The method of feature 17, wherein the quenched metal workpiece is a sheet or plate.
   19. The method of any of features 17-18, wherein the shape of the heated metal workpiece is flat and the flat shape of the first and/or second dies is complementary to the flat shape of the heated metal workpiece.
   20. The method of feature 17, wherein the shape of the heated metal workpiece is three-dimensional and the pressurized contact between the flat first and second dies and the heated metal workpiece forms the heated metal workpiece into the flat quenched metal workpiece.
   21. The method of feature 16, wherein at least one of the first and second dies has a three-dimensional mold shape for producing a three-dimensionally shaped quenched metal workpiece.
   22. The method of feature 21, wherein the shape of the heated metal workpiece is three-dimensional and the three-dimensional mold shape of the first and/or second dies is complementary to the three-dimensional shape of the heated metal workpiece.
   23. The method of feature 21, wherein the three-dimensional mold shape of the first and/or second dies is different than the shape of the heated metal workpiece and the pressurized contact between the first and second dies and the heated metal workpiece forms the heated metal workpiece into the three-dimensionally shaped quenched metal workpiece.
   24. The method of feature 16, wherein the shape of the heated metal workpiece is three-dimensional, the method further comprising:
forming a metal workpiece to provide a shaped metal workpiece; and
heating the shaped metal workpiece to produce the heated metal workpiece.
   25. The method of feature 24, wherein the step of forming further comprises at least one of sheet metal braking, die forming, progressive die forming, welding, cutting, machining, 3D printing, or combinations thereof.
   26. The method of feature 25, wherein the step of heating further comprises heat-treating the metal workpiece.
   27. The method of feature 26, wherein the step of forming includes at least one of laser cutting, welding, or both and the step of heat-treating includes at least one of:
maintaining the shaped metal workpiece at a HAZ heat-treating temperature for a predetermined time sufficient to recrystallize at least one unwanted crystalline structure of a heat affected zone (HAZ) created in the shaped metal workpiece by the welding; or
maintaining the shaped metal workpiece at a cut edge heat-treating temperature for a predetermined time sufficient to recrystallize at least one unwanted crystalline structure formed along a cut edge of the shaped metal workpiece during the step of laser cutting.
   28 The method of any of features 1-27, further comprising cooling at least one of the first die or the second die.
   29. The method of feature 28, wherein the step of cooling at least one of the first die or the second die is performed by a liquid cooling system of the press, wherein a liquid coolant of the liquid cooling system does not contact the workpiece.
   30. The method of any of features 1-29, further comprising heating at least one of the first die or the second die.
   31. The method of feature 30, wherein the step of heating at least one of the first die or the second die is performed by one or more of:
at least one electrical element of the press, wherein the at least one electrical element does not contact the workpiece; or
a liquid heating system of the press, wherein a liquid of the liquid heating system does not contact the workpiece.
   32. The method of any of features 1-31, wherein the step of closing the press further comprises bringing at least one additional die of the press into pressurized contact with the heated metal workpiece.
   33. The method of any of features 1-32, wherein the initial workpiece temperature exceeds a melting point of at least one of the first die or the second die.
   34. The method of any of features 1-33, wherein the step of continuing the pressurized contact between the first and second dies and the metal workpiece includes continuing the pressurized contact at a pressure equal to or greater than 1 psi.
   35. A method for hybrid quenching of metal comprising:
transferring a heated metal workpiece having a primary substrate, one or more out of plane features, and an initial workpiece temperature to a press, the press comprising:
   a first die having an initial first die temperature, the initial first die temperature being lower than the initial workpiece temperature,
   a second die positioned opposite the first die and having an initial second die temperature, the initial second die temperature being lower than the initial workpiece temperature, and
   one or more voids defined in the first die, the second die, or both, at least one of the one or more voids corresponding to and sized to receive one of the out of plane features of the heated metal workpiece,
   wherein the first and second dies are each constructed of a material having a thermal conductivity equal to or greater than 90 W/mK at a temperature of 70 F;
closing the press to bring the first die and the second die into pressurized contact with at least 50% of a surface area of the primary substrate of the heated metal workpiece;
flowing a fluid through the one or more voids to flow over the corresponding one of the out of plane features of the heated workpiece received therein;
continuing both the fluid flow through the one or more voids and the pressurized contact between the first and second dies and the primary substrate to cool the metal workpiece from the initial workpiece temperature to a quenched workpiece temperature;
terminating the fluid flow and opening the press when the metal workpiece reaches the quenched workpiece temperature to produce a quenched metal workpiece; and
removing the quenched metal workpiece from the press.
   36. The method of feature 35, wherein the fluid is at least one of water, oil, salt water, a molten salt, a molten metal, glycol, a dielectric fluid, or combinations thereof.
   37. The method of any of features 35-36, wherein the press further comprises a fluid input port and a fluid output port to permit flowing of the fluid through the one or more voids.
   38. The method of any of features 35-37, wherein the first and second dies are configured to conduct heat away from both the metal workpiece and the flowing fluid.
   39. The method of feature 38, wherein the first and second dies are constructed of a material having higher thermal conductivity, effusivity, and diffusivity than the metal workpiece.
   40. The method of any of features 38-39, wherein the first and second dies are configured to conduct sufficient heat away from the flowing fluid to prevent the flowing fluid from undergoing a phase change in the one or more voids.
   41. The method of any of features 38-40, wherein a mass flow rate of the flowing fluid permits the flowing fluid to convect heat from the metal workpiece to the first and second dies without undergoing a phase transformation in the one or more voids.
   42. The method of any of features 35-41, further comprising cooling the quenched metal workpiece to a fully cooled temperature to produce a metal article.
   43. The method of feature 42, further comprising laser cutting the metal article to produce at least one cut edge in the metal article.
   44. The method of feature 43, further comprising:
reheating the metal article to a heat-treating temperature equal to or greater than the fully cooled temperature and less than the initial workpiece temperature;
maintaining the metal article at the heat-treating temperature for a predetermined time sufficient to recrystallize at least one unwanted crystalline structure formed along the cut edge during the step of laser cutting; and
recooling the metal article to the fully cooled temperature to produce a healed metal article.
   45. The method of feature 44, further comprising:
transferring the reheated metal workpiece to the press;
reclosing the press to bring the first die and the second die into pressurized contact with the reheated metal article; and
flowing the fluid through the one or more voids to flow over the corresponding one of the out of plane features of the reheated workpiece received therein.
   46. The method of any of features 42-45, further comprising:
creating a heat affected zone (HAZ) of the metal article by welding the metal article;
reheating the metal article to a HAZ heat-treating temperature greater than the fully cooled temperature and less than the initial workpiece temperature;
maintaining the metal article at the heat-treating temperature for a predetermined time sufficient to recrystallize at least one unwanted crystalline structure of the HAZ; and
recooling the metal article to the fully cooled temperature to produce a healed metal article.
   47. The method of feature 46, further comprising:
transferring the reheated metal workpiece to the press;
reclosing the press to bring the first die and the second die into pressurized contact with the primary substrate of the reheated metal article; and
flowing the fluid through the one or more voids to flow over the corresponding one of the out of plane features of the reheated workpiece received therein.
   48. A method for bending metal by press braking comprising:
laser cutting a metal plate to form a protrusion alignment feature thereon at a location to be bent, the protrusion alignment feature including:
   a rounded protrusion extending outward from an edge of the metal plate and oriented along the edge in an out of plane direction relative to the metal plate, and
   first and second filleted transitions positioned along opposing sides of the rounded protrusion between the rounded protrusion and the metal plate; and
bending, using a press brake, the metal plate at a location indicated by the protrusion alignment feature.

### BRIEF DESCRIPTION OF THE DRAWINGS

FIG. 1 illustrates a functional flow diagram of a solid state quenching process in accordance with various embodiments in accordance with various embodiments.

FIG. 2 illustrates interface temperatures of various candidate die materials with a steel workpiece at 1600 F in accordance with various embodiments.

FIG. 3A illustrates a lower portion of a hybrid solid state and fluid quench (HSSQ) press, including a lower die having voids formed therein in accordance with various embodiments.

FIG. 3B. illustrates the HSSQ press of FIG. 3A including a workpiece being removed therefrom.

FIG. 3C illustrates a workpiece produced by the HSSQ press of FIG. 3A.

FIG. 4 illustrates a cutout alignment feature for bending by press braking in accordance with the prior art.

FIGS. 5A-5C illustrate a protrusion alignment feature for bending by press braking in accordance with various embodiments.

### DETAILED DESCRIPTION

Provided herein are methods and systems for solid state quenching (SSQ) of metal. The term “Solid State Quench” is used herein to describe a quenching process that uses primarily contact cooling where the cool element/medium is a solid, as opposed to the typical wet quench using water or other liquid.

### Solid State Quenching

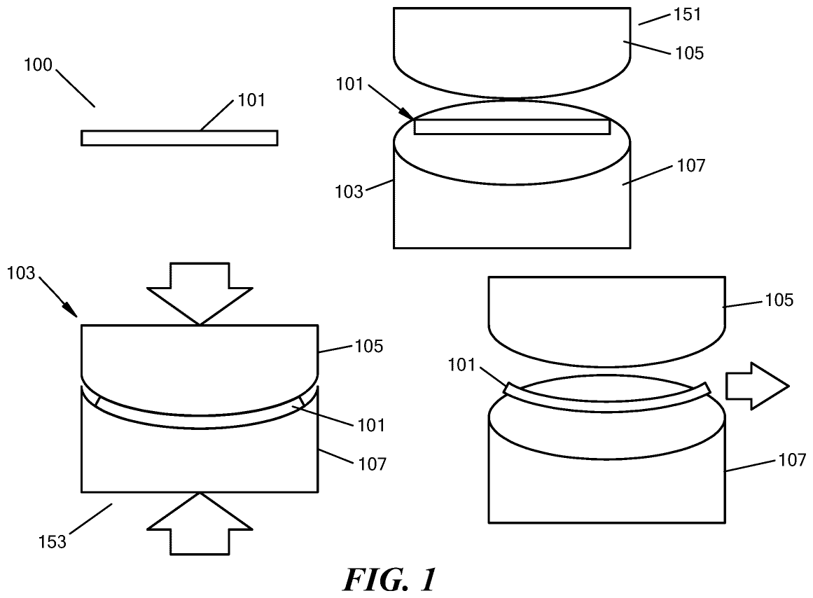

An exemplary SSQ process 100 is described in FIG. 1. At step 151, a heated metal workpiece 101 having an initial workpiece temperature is transferred to a press 103 having an upper die 105 and a lower die 107, each maintained at a lower temperature than the initial workpiece temperature of the heated metal workpiece 101. At step 153, the press 103 is closed, bringing the heated metal workpiece 101 into pressurized contact with the upper and lower dies 105, 107. The pressurized contact between the upper and lower dies 105, 107 and the workpiece 101 is maintained for a time sufficient to cool the workpiece 101, by solid state contact conduction, to a desired temperature, at which point, in step 155, the press is opened and the workpiece 101 is removed from the press 103.

At that point, the workpiece 101 can be passed on for downstream processing (e.g., additional heat-treatment and/or tempering), left to autotemper by ambient air cooling, and/or considered to be a final metal article.

This SSQ process 100, by holding the workpiece 101 in pressured contact with the upper and lower dies 105, 107, produces stress free metal articles, objects, components, and/or products (hereinafter “metal articles”). In addition, by using materials having high thermal conductivity, heat transfer can be accomplished in seconds by solid state contact conduction and is highly repeatable. In this manner, enormous cost savings, increases in material throughput, and decreases in scrap rate are realizable over the prior art.

In some embodiments, the SSQ process 100 can be used solely for quenching (or tempering or other heat-treatment purposes), wherein the press 103 exerts comparatively light pressure to maintain contact between the workpiece 101 and the upper and lower dies 105, 107 and, preferably, to maintain shape of the workpiece 101 during the quenching operation (e.g., to prevent heat distortion such as warping, buckling, or other distortion). During such operations, the dies 105, 107 can be brought into contact with the workpiece 101 to a pressure of at least, for example, 1 psi or more, including, 5 psi, 10 psi, 20 psi, 50 psi, 100 psi, or more, holding the pressure for a time necessary for the sheet article to cool sufficiently, the time being at least 1 second, after which the dies are opened and the metal article removed.

Alternatively, in some embodiments, the SSQ process 100 can be used for both hot metal stamping/forming and quenching, wherein the SSQ process 100 is used for both forming and quenching the heated metal workpiece 101. In such embodiments the press 103 can instead exert sufficient pressure between the upper and lower dies 105, 107 and the workpiece 101 to form the workpiece 101 into a desired different shape. In many such embodiments the forming and quenching can be advantageously performed in a single step. In such embodiments, because the workpiece is hot and therefore more ductile, the dies 105, 107 can be brought into contact with the workpiece 101 at similar pressures to the quench-only process, about at least 1 psi to about 200 psi or more. Such comparatively low forming pressures substantially reduce the size, cost, wear, and tear on forming equipment and tooling when compared with the 3,000 psi or more required to perform cold forming operations on metal workpieces. However, it will be apparent that, in some embodiments, higher forming pressures may have utility and be used in connection with SSQ. In such operations, the pressured contact is held for a time necessary for the sheet article to cool sufficiently, the time being at least 1 second, after which the dies are opened and the metal article removed.

It is noted that, although frequently shown and described herein in connection with SSQ performed for solution hardening of steel plate or sheet material, the heated metal workpiece 101 can, in accordance with various embodiments, be any metal object to be quenched, of any shape, composition, and/or desired properties. In addition, although described herein in the context of applications where solution hardening of the metal workpiece 101 is desired, such SSQ can be used to produce quenched metal articles having any suitable desired properties for use in any suitable application, including, for example, aerospace, armor, industrial, automotive, agricultural, mining, and other applications.

In accordance with various embodiments, the metal workpiece 101 can be of any size, shape, or thickness. For example, the metal workpiece 101 can be flat, contoured, complex contoured, domed, a hollow cylinder, chest plate shaped, vehicle panel shaped, bent (e.g., in some embodiments having a bend radius to thickness ratio of less than 5:1, including less than 2:1, or even equal to 1:1. In addition, the metal workpiece can be constructed of any suitable metal including, for example, iron, steel, aluminum, titanium, copper, nickel tungsten, any other suitable metal that would benefit from shape-controlled cooling and/or rapid quenching to produce preferred microstructures, as well as alloys and/or combinations thereof. It will be apparent in view of this disclosure that any thickness of steel or other metal material (e.g., thicknesses equal to or exceeding 0.01″, including about 0.01″, 0.1″, 0.25″, 0.5″, 1″, 1.25″, 1.5″, 1.75″, 2″ or more), or even workpieces 101 comprising multiple such layers of metal material, can be quenched using the SSQ processes described herein. For example, in some embodiments, SSQ 100 can be performed on a metal workpiece comprising a 0.25″ steel plate.

The upper and lower dies 105, 107 can be comprised of any suitable material capable of transferring heat away from the workpiece 101 at a rate sufficient to produce the desired properties for a metal article being produced. For example, in most embodiments, the upper and lower dies 105, 107 can be constructed of a material having a thermal conductivity equal to or greater than 90 W/mK at a temperature of 70 F and preferably greater than 100 W/mK at 70 F. Such materials can include, for example, aluminum, copper, magnesium, zinc, silicon carbide (SiC), aluminum nitride (AlN), bronzes, beryllium-copper, diamond, highly thermally conductive ceramics, and any alloys and/or combinations thereof having a suitable thermal conductivity.

In addition, each of the upper and lower dies 105, 107 can be any suitable shape, including, for example, flat or any complementary or partially complementary shape of the workpiece 101 capable of providing enough contact area between the dies 105, 107 and the workpiece 101 for transferring heat away from the workpiece 101 at the rate sufficient to produce the desired properties for a metal article being produced. Such shapes can include flat, contoured, complex contoured, domed, cylindrical, hollow cylindrical, semi-cylindrical, chest plate shaped, vehicle panel shaped, bent (e.g., in some embodiments having a bend radius to thickness ratio of less than 5:1, including less than 2:1, or even equal to 1:1.

Furthermore, it will be apparent in view of this disclosure that, although shown and described herein with reference to presses 103 having upper and lower dies 105, 107, more complex workpiece shapes may require presses 103 having any number of dies, arranged in any orientation relative to the workpiece 101, and configured to cooperatively provide pressurized contact with the workpiece 101. Furthermore, any one or more of such dies 105, 107 may be stationary and/or movable in accordance with various embodiments. For example, in some embodiments, a hollow cylindrical workpiece (e.g., a hub, a tube, and/or a ring) can be slid over a stationary or expandable inner cylindrical die and then two semi-cylindrical dies can be closed to maintain pressurized contact between the semi-cylindrical dies and an outer diameter of the hollow cylindrical workpiece as well as producing pressurized contact between an inner diameter of the hollow cylindrical workpiece and the inner cylindrical die.

Depending on the composition and/or the thickness of the metal workpiece and the initial temperature thereof, the initial temperatures of the upper and lower dies 105, 107, composition of the upper and lower dies 105, 107, pressure exerted by the press, and/or thicknesses and masses of the upper and lower dies 105, 107 can vary to optimize material shape and properties of the produced metal article. Furthermore, it will be apparent in view of this disclosure that the temperatures, thickness, masses and/or specific composition of the upper and lower dies 105, 107 can be the same or can be different in accordance with various embodiments. For example, in some embodiments, the ratio of the mass of the dies 105, 107 to the mass of the workpiece 101 can be 0.5:1 or greater, including, for example, 1:1, 2:1, 5:1, 10:1, or more. In some embodiments, the mass of the upper die 105 and the mass of the lower die 107 can be the same. In some embodiments, the mass of the upper die 105 and the mass of the lower die 107 can be different, wherein a ratio between a mass of the dies 105, 107 is up to 10:1, or even more.

For example, in some embodiments, the SSQ process uses thermally conductive dies with sufficient mass to quench hardenable steels, such as armor steel, at a rate faster than the critical quench rate to form martensite. A martensitic structure in these steels is what provides the ballistic resistance required for high hardness armor steel applications in body armor, structures, and vehicles. There are a number of die materials such as, for example, silicon carbide (SiC), aluminum nitride (AlN), pure copper and copper alloys, bronzes, beryllium-copper, and others which possess the high thermal properties (e.g., conductivity, effusivity, diffusivity) needed for rapid quench and the resulting high hardness properties of the steel. However, testing has shown that aluminum appears to be most viable due to not only its thermal characteristics and durability, but also because it is relatively inexpensive and easy to machine into die sets and does not tend to stick, fuse, or otherwise bond to the workpiece 101. In general, for quench hardening wherein the workpiece 101 is a metal sheet or plate, the workpiece 101 can preferably have an initial workpiece temperature greater than 500 F (e.g., for aluminum workpieces), or greater than 1000 F (e.g., for steel or titanium), while the upper and lower dies 105, 107 have lower initial first and second die temperatures lower temperature, preferably less than 500 F, less than 150 F, or about room temperature (e.g., 70 F). During the pressing operation, the dies can be brought into contact with the workpiece to a pressure of at least, for example, 1 psi or more, including, 5 psi, 10 psi, 20 psi, 50 psi, 100 psi, or more, holding the pressure for a time necessary for the sheet article to cool sufficiently, the time being at least 1 second, and the dies opened and the metal article removed.

In general, the dies 105, 107 can be heated and/or cooled via electrical elements, fluids (including liquids) and/or using the thermal transfer from the workpiece to provide desired temperatures at desired times during processing of the workpiece.

In some embodiments (not shown), the upper and lower dies 105, 107 can be liquid cooled and/or heated via a closed-loop heat exchanger system wherein fluid is pumped through passages within the dies 105, 107 along a closed loop but never contacts the metal workpiece 101. Such liquid cooling and/or heating can aid in maintaining a desired temperature of the dies 105, 107 and/or reducing a time for return-to-baseline-temperature between quenching operations. From an environmental perspective, such closed liquid cooling and/or heating loops advantageously do not directly encounter metals being processed, thus avoiding contamination to the cooling fluid and without sacrificing fluid. Thus, greater precision is maintained without environmental fall out. This is an advantage over traditional steel making and fluid-based quenching, which are energy intensive for both heating and cooling and require the use of large quantities of fluid. Even in conventional closed loop systems wherein cooling and/or heating fluid is recaptured, the contaminated fluid must regularly be cleaned and/or replaced in order to avoid unwanted changes in specific heat of the fluid, which can negatively affect processing. In addition, because the fluid is not contaminated in SSQ, such a closed system using sustainable heat transfer techniques can be provided via geothermal cooling and/or heating of the dies as well.

In embodiments wherein the upper and lower dies 105, 107 are heatable (e.g., by liquid heating as described above and/or one or more electrical elements of the press) to control a temperature thereof, such capability can advantageously permit greater control over initial die temperatures and/or facilitate any of a number of quenching, tempering, partitioning, and other metallurgical processes as explained below. With respect to heating via electrical elements, as with the heated or cooled liquid used for liquid heating and/or cooling, electrical elements used for heating are configured to heat the press only and preferably do not contact the workpiece.

In some embodiments, in order to further reduce friction, bonding, and/or sticking between the dies 105, 107 and the workpiece 101 during SSQ, one or more contact surfaces of the dies 105, 107 can be coated with a lubricant. Such lubricants can include for example, grease, impregnated grease, sprayed or sputtered coatings, painted coatings, oxide layers, or any other suitable lubricant capable of reducing friction between the dies 105, 107 and the workpiece 101 without resulting in unwanted contamination, damage, and/or an unacceptable reduction in thermal performance of the SSQ 100 process. Such lubricants, in accordance with various embodiments, can be entirely or partially configured to survive the SSQ process for multiple usage or can be entirely or partially for single-use applications.

In some embodiments, such lubricants can be useful wherein the workpiece 101 includes one or more holes formed therein. In such embodiments, thermal expansion can change dimensions of the workpiece 101 during heating can change a shape and/or size of the holes during processing. In a substantially frictionless environment, thermal contraction during the rapid cooling associated with SSQ can very closely recover the original hole dimensions. However, where friction, bonding, and/or sticking between the dies 105, 107 and the workpiece 101 occur, the thermal contraction during the rapid cooling associated with SSQ can result in distorted or differently dimensioned holes. Thus, use of such lubricants can provide lower friction, resulting in more closely toleranced hole dimensions, which is advantageous because it is impracticable to drill or otherwise “plunge cut” hardened metals such as armor steels. Instead, such holes must be formed undersized in advance and then ground along their edges to a final dimension after hardening. This grinding process is expensive because it is both time consuming and results in very high tooling wear. Accordingly, the less undersized (i.e., closer to specification dimensions) the holes can be before hardening, the lower the cost of the final metal article/product. As explained above, lubricating the dies 105, 107 can reduce or eliminate such grinding operations.

In addition, although described above in the context of the production of flat plates and sheets, SSQ 100 is advantageously also effective with three-dimensional die sets that can provide curves, contours, and surface features previously unachievable using conventional forming methods for armor and other high-hardness metal products.

### Metallurgical Processes Achievable by SSQ

Metals often undergo heat-treatment processes like quenching and tempering to enhance their mechanical properties. The quench rate, or the speed at which the metal is cooled, significantly influences the final material characteristics. Rapid quenching can result in increased hardness, but it also introduces the risk of cracking due to thermal stresses. Therefore, finding the optimal quench rate is essential to balance hardness and toughness. Thermally conductive dies with ample mass and heat transfer mitigate this issue and take it from a highly uncontrollable process using water or oil as a quenchant and instead replace it with a tool set that can not only extract heat but can be manipulated to have tightly controlled heat extraction rates (quench kinetics).

In the context of medium carbon alloy steels, a critical aspect is to avoid the formation of potentially undesirable phases, such as pearlite or bainite, during rapid cooling. Tailoring the quench rate ensures that the steel undergoes a transformation sequence conducive to the desired martensitic microstructure.

For example, in the process of transforming austenite to martensite during rapid quenching of steel, particularly in medium carbon alloys such as 4340 and 4140 (or similar high-hard, very-high hard, and ultra-high hard ballistic armor steels), the quench rate plays a pivotal role in determining the resulting microstructure and mechanical properties. This rapid transformation is a critical aspect of heat-treatment for enhancing the hardness and strength of armor steel products.

Austenite, the high-temperature phase, is first formed during the heating of steel. In the subsequent quenching step, typically done via water or oil, but now concerning the use of high thermal conductivity metals (e.g., Aluminum, copper, silver, gold, etc.), the steel is rapidly cooled uniformly, and the formation of martensite is initiated. The quench rate is of paramount importance, as it influences the diffusion of carbon atoms within the steel lattice, dictating the final microstructural characteristics.

When quenching to form Martensite, a Martensitic start time signifies the onset of martensite formation during rapid cooling from the austenitic phase. Controlling the quench rate is crucial to hitting this point accurately, ensuring the prompt initiation of martensite formation. Similarly, a Martensitic finish time represents the completion of martensitic transformation. However, undue delays in achieving full martensitic conversion may lead to the formation of undesired phases such as pearlite or bainite, compromising the intended material properties.

An example of the importance of quench rate can be illustrated by excessively slow quenching. In particular, when austenite is cooled to a temperature below a Lower Critical Temperature (LCT) too slowly, instead of forming martensite, the structure that is formed is Pearlite, which is brittle and thus unsuitable for use as armor. As the cooling rate increases, the pearlite transformation temperature is lower, below martensite finish, thus avoiding such issues. Therefore, a proper quench rate must be maintained to prevent undue delays in achieving full martensitic conversion.

Conversely, cooling too rapidly can introduce thermal distortion (warping, etc.) and internal thermal stresses to the workpiece. Such distortion and thermal stress are problematic because they negatively impact part dimensioning, weldability, fatigue resistance, and environmentally assisted cracking. The precise control offered by SSQ alleviates these concerns in two ways. First, this increased control permits conductive die sets, along with proper starting temperatures and austenitic soaking times, to be designed to produce an optimum cooling rate to achieve optimum properties with the least amount of distortion or internal stresses. Second, because the workpiece surfaces are being held in pressurized contact with the dies, instead of being released to permit fluid flow thereover, the desired shape of the workpiece is mechanically maintained throughout quenching, preventing distortion.

It is noted that, although for alloys such as ballistic armor steels, martensite formation is critical, there are other applications where other properties, having a mixed or different microstructure, are desired. In such instances, the precise control over cooling rate offered by the present technology can be used to achieve such unique properties because the microstructure and mechanical properties of the metal workpiece are significantly altered by cooling rate. For example, interrupting a rapid quenching process at a specific temperature by holding the workpiece at a constant temperature, followed by another cooling process in the same or a subsequent die set, allows a steel article to form bainite, which, while not being as hard as martensite, can be used for other high strength and high toughness applications. For example, such an approach would result in even more dimensional stability, less distortion, and fewer internal stresses than even an optimized martensite-forming quench.

For some heat-treated steel applications outside of ballistic armor, some pearlite may be desirable. In such embodiments, a cooling rate which is not high enough to produce 100% martensite may be used. For example, in some embodiments the austenite may be transformed to 50% pearlite and 50% martensite. Such processes are very challenging via water, oil, glycol, dielectric fluids, or other methods of quenching such as salt, molten salts, or molten metal baths but can easily be accomplished via SSQ using temperature controlled die sets.

More generally, because thermally conductive die sets can be developed to be heated or cooled using thermal controls, other types of mixed quenches are feasible using a single die or multiple dies in sequence. The dies can be heated and cooled using various methods and the SSQ can be performed either in a single die or in progressive dies. That is, workpieces can be quenched to a certain temperature and then a die can be heated to hold at that temperature to further reduce internal stresses through tempering, austempering, martempering or quenching and partitioning. In the context of steel this can include the formation of bainite, mixed pearlite and martensite and a wide range of other microstructures via processes such as austempering, martempering and various partitioning cycles.

For example, austempering is unique heat-treatment which is challenging using liquid quenchants. It is a process when austenite transforms into lower bainite. Generally, the process is carried out following these steps: Heating steel above austenitizing temperature, quenching at a constant temperature above the martensitic start temperature of a particular steel, holding at temperature until the bainitic transformation is completed, and finally cooling the steel to room temperature.

Also, for example, martempering, also known as ‘marquenching,’ is a heat-treatment wherein steel is heated to the austenitizing temperature range and quenched to a temperature above the martensitic transformation start temperature. The steel can then be held in thermally controlled conductive die sets for sufficient time until the temperature of the component is uniform and then the steel can be air cooled through the martensite formation range. Thus, martempering effectively hardens and tempers the steel at the same time. SSQ permits performing such processes while keeping distortion to a minimum. In some instances, subsequent tempering can also be carried out to improve toughness even further.

### Quenching and Partitioning Heat-Treatment

Provided herein is a quenching and partitioning heat-treatment. Such treatment requires highly controlled processes aimed at optimizing the microstructure and properties of the steel. This technique is particularly relevant in the context of armor steel products and is made feasible by the thermally conductive and controlled die sets provided by the present SSQ technology. These processes can be used to repeatably and consistently produce customizable material properties. For example, such processes could be used to produce very hard alloys which are viable to stop high velocity and armor piercing rounds, but also possess sufficient toughness to resist the effects of blast events.

One example of a quenching and partitioning process could include, for example, a first step of heating the steel to austenite and then quenching to a critical temperature below martensite start (Ms), resulting in partial transformation of the structure of the steel to martensite. In a second step (partitioning), the steel temperature is raised slightly and rapidly, to force carbon atoms to move from the martensite into the austenite. This carbon-rich austenite becomes stable and does not transform into martensite after further cooling to room temperature. Such processes would have utility in, for example, armor, wherein very small amounts of stable austenite have been found to be beneficial in armor steels as related to blast resistance and adiabatic shear. The above-described quenching and partitioning process has not, prior to the present technology, been possible or practicable. In armor steel applications, due, for example, to the aforementioned benefits of stable austenite, such partitioned heat-treatments offer the potential to fine-tune material properties, providing a strategic advantage in terms of both performance and durability. The thermally conductive and controllable die sets of the present SSQ technology thus provide a unique means to control the holding and quenching steps either in a single die or in subsequent die-sets with the appropriate thermal controls.

### Processing of Non-Steel Materials

In connection with the processing of aluminum, SSQ can be used to return heat-treatable aluminum alloys back to W temper, which is a requirement to achieve a baseline for subsequent artificial aging, used to impart strength into heat-treatable aluminum alloys.

With respect to the processing of titanium, titanium is a material of interest for numerous applications in aviation, armor, and other industries. In many such applications, obtaining desired properties requires the material to remain below its alpha/beta transition temperature at all times. However, forming cold titanium can be extremely challenging.

The SSQ process of the present technology can contour and quench the titanium at temperatures lower than that temperature without the deleterious effects of cold forming. Super plastic forming of some Ti alloys is also possible using thermally conductive dies.

### Development of New Alloys

Due to the high controllability and mechanical restraint features of the present technology, it will also be possible to develop new alloys for quenchable workpiece materials in order, wherein desirable properties can be maximized in previously impossible ways by exploiting the effectiveness of the conductive die sets. Currently all experimental SSQ work has been with commercially available alloys, but research is ongoing to match alloys to the process of the present technology to optimize material properties for a plurality of applications.

For example, in connection with steel, adjusting the composition of alloy steels by diluting or adding specific alloying elements can impact material properties and/or thermal expansion coefficients. Alloying elements can include nickel, manganese, chromium, any other alloying elements, or combinations thereof can be added or diluted in accordance with various embodiments. In addition, alloying elements used in existing alloys can, in some embodiments, be substituted with elements with similar atomic sizes but different thermal or other characteristics to achieve desired material properties.

### Retreatment of Processed Workpieces

In some embodiments, metal workpieces can undergo SSQ processing from a “green” state (e.g., hot rolled or cold rolled “raw” material, whether formed or unformed, welded or unwelded, cut or uncut) and/or in any other state including, for example, an annealed state, a normalized state, a heat-treated state, a quenched state, a tempered state, and/or combinations thereof. For example, armor steels can be processed using SSQ from an already quenched and tempered condition or from a hot rolled or cold rolled form because the steel or steels will be fully or at least partially austenitized during the SSQ process. As such, the SSQ process advantageously opens up the supply chain for armor alloys as an expensive water quench and temper line is no longer necessary to produce these high hardness ballistic resistant grades. Some steels, such as flash processed bainitic steels may be formed at lower temperatures and not fully austenitized to retain the bainitic structure but allow for much easier forming and contouring.

### Elimination and Reduction (“Healing”) of Weld Effects

Using the SSQ of the present technology, laser welded, friction stir welded or traditionally welded metal articles having either no weld wire or weld wire that is matched to the workpiece can be completely austenitized and requenched appropriately (“healed”) to reduce or eliminate heat affected zones which compromise the integrity of the material properties.

Because of the mechanical restraint and highly controllable. localizable quench rates afforded by the present technology, use of the present technology permits the tailoring of welded metal articles having varying thicknesses and material grades in various locations without compromising metal properties at weld locations. For example, armor articles and/or panels may require varying thicknesses and/or grades of material in different locations for selectively balancing ballistic resistance and weight savings in vehicles or personal body armor.

Furthermore, in many applications, due to compromised material properties in the heat affected zones of welds in a metal article, reinforcement must be provided by the use of thicker material and/or the welding on of additional layers/reinforcement elements. These reinforcements add significant weight and, particularly where additional layers or elements are being welded onto the primary article, create additional compromised failure points. By “healing” the weld and avoiding the need for such measures, metal articles produced using SSQ of the present technology can be significantly lighter and exhibit better material integrity.

### Elimination and Reduction (“Healing”) of Cutting Effects

Similar to the heat affected zones associated with welding, thermal cutting, including laser and plasma cutting, can give rise to heat affected edges which can compromise the integrity of the material properties. Conventionally, this requires the use of slow, expensive water jet cutting of as-quenched armor steels. Using the SSQ of the present technology, such heat affected edges of the workpiece can be completely austenitized and requenched appropriately (“healed”) to reduce or eliminate heat affected edges which compromise the integrity of the material properties.

### Metallurgical Advantages

As discussed above, there are several disadvantages to traditional “Hot Stamping” (or “Press Hardening”) of steel sheet and/or plate. Traditional hot stamping uses matched metal (steel) tooling, with the workpiece heated to a high temperature (e.g., 1650 F or so), and formed (often drawn over the tool with extensive part stretching and thinning) and cooled rapidly in the tooling under pressure. The steel tooling is often a high-grade steel, hardened to enhance wear resistance and promote long life in service. The rapid cooling tends to produce a steel article with enhanced hardness using alloys of steel specially developed for these challenging high strength automotive applications, where high hardness (530, 550, 570, or 650 Brinell, among other requirements) is necessary to produce an armor article capable of resisting ballistic threats (as specified in MIL_DTL_46186B and/or MIL-DTL-32332A for example). However, a typical press hardening process, using steel tooling (or similarly low-conductivity tooling materials such as aluminum bronze), is incapable of producing steel armor articles with hardness values approaching 530 Brinell for gauges having thicknesses greater than 0.125″, particularly when thicknesses exceed 0.1875″ or even 0.25″ or more. Traditionally hot-stamped armor articles requiring 570 Brinell hardness are only achievable at even thinner gauges.

Thus, the typical approach to producing armor articles with high hardness (e.g., Brinell 530, 550, 570, or 650) is to heat the armor article to a high temperature, above 1500 F or so, and rapidly quench the armor article with water, oil, salt water, molten salts, molten metals, glycol, dielectric fluids, and/or a variety of other fluid quenchants. Because such fluid quenchants can boil and insulate the surface from cool water, thus thwarting the quench, it is often necessary to use elaborate multi-nozzle or other turbulence producing means to quench the armor articles as uniformly as possible. Any nonuniformity in the quench can result in warping, cracking, or other non-uniform shrinkage phenomena, as well as non-uniform/inadequate hardness. Further, formed armor articles with non-flat geometry are often made by hot stamping to form the armor article (in cooled steel dies), followed by heating and wet quenching as previously described. Note that the non-flat geometry poses problems in the quenching process because of the geometry, and elaborate, part-specific quenching systems are often used, complicating the quenching process, and adding cost.

The present technology overcomes the hardness limitations encountered with steel tooling by using solid, highly conductive tooling having significantly higher thermal conductivity, thermal effusivity, and thermal diffusivity, than traditional steel tooling; driving a much faster quench in a hot stamping process.

### Unexpected Results and Metallurgical Explanations

### Unexpected Results

Recognition of the viability of this SSQ process results from a surprising discovery of the inventors that, in some embodiments, the upper and lower dies 105, 107 can unexpectedly be implemented to quench heated metal workpieces 101 wherein the initial workpiece temperature substantially exceeds a melting point of the material or materials used to construct the dies 105, 107. For example, in solution hardening of steel plate material, the initial temperature of the steel workpiece may be 1650 F and the upper and lower dies 105, 107 may be constructed of aluminum 6061, which has a melting point between about 1080 F to about 1205F and enters solidus at approximately 1080 F. For this reason, it was expected that the aluminum would melt on contact and damage the tooling, particularly when used in connection with thicker workpieces, which hold more total heat energy than thinner workpieces.

### Metallurgical Analysis

When a comparatively cool die is brought into contact with a hot workpiece during quenching and/or forming of the workpiece, a variety of cooling mechanisms take place at different time scales.

The first is the initial (also referred to as “instantaneous”) interface temperature on first contact. The temperature at the interface is governed by the starting temperature and the thermal effusivity of each material. Effusivity drives the quench rate of the workpiece and determines the initial interface temperature. A higher effusivity die material will yield higher quench rates for the workpiece. This mechanism takes place over a time spanning between a fraction of a second and a few seconds.

In a second stage, as the heat moves from the interface between the workpiece and the surface of the die into the greater die material, the heat removal becomes governed by thermal diffusivity of the die material. Put simply, the higher the thermal diffusivity, the faster the heat can be removed and transported away from the interface and, thus, the workpiece. This mechanism takes place over a time spanning from a few seconds to a few minutes.

A third stage is driven to a large part by the mass of the components, as well as their thermal conductivity and heat capacity, and controls an equilibrium temperature of the combined workpiece/die system at longer time scales. The more massive the die, the lower the equilibrium temperature. Because the equilibrium temperature can last for a longer time, it can be thought of as a “hold” temperature after quenching if the press is not opened and the workpiece removed before equilibrium is reached. Where the equilibrium temperature is above a specific threshold, such “hold” temperatures may have tempering implications on the workpiece. This mechanism takes place over a time spanning between a few minutes to tens of minutes.

In some instances, a fourth and final stage, rarely used, holds contact pressure between the dies and the workpiece, permitting both to cool further as heat leaks out to the surrounding equipment and atmosphere.

In some embodiments, the upper and lower dies will preferably expand to a greater extent than the corresponding shrinkage of the metal workpiece during quenching, thereby maintaining pressurized contact between the upper and lower dies and the workpiece.

Thermal diffusivity and thermal effusivity are combinations of three more basic material properties, namely density “ρ”, thermal conductivity “K”, and heat capacity “Cp”. Thermal diffusivity is given by the ratio K/(ρCp) and thermal effusivity by the square root of the product KρCp.

Table 1 below shows the thermal conductivity, effusivity, diffusivity, among other relevant properties for a variety of materials.

TABLE 1

| | | Thermal | Heat | | |
|---|---|---|---|---|---|
| | Density | Conductivity | Capacity | Diffusivity | |
| Material | ρ (kg/m³) | K (W/mK) | Cp (J/kgK) | (m²/s) | Effusivity |
| Steel 4340 | 7850 | 36.40 | 417.00 | 1.11E−05 | 10916 |
| Aluminum 6061 | 2720 | 154.00 | 877.00 | 6.46E−05 | 19167 |
| Berillium-copper | 8290 | 81.00 | 397.00 | 2.46E−05 | 16327 |
| Copper-pure | 8940 | 390.00 | 383.00 | 1.14E−04 | 36543 |
| Titanium 6-4 | 4500 | 88.00 | 500.00 | 3.91E−05 | 14071 |
| SiC | 3160 | 325.00 | 750.00 | 1.37E−04 | 27753 |
| Carbon Steel | 3160 | 50.00 | 750.00 | 2.11E−05 | 10886 |
| CRUCIBLE ® 3V ® | 3160 | 24.00 | 750.00 | 1.01E−05 | 7542 |
| tool steel | | | | | |

As shown, most conventional die materials exhibit poor thermal conductivity, diffusivity, and effusivity. For example, the thermal conductivity of carbon steel is in the range of 36 to 50 W/mK, steel with 1% tungsten is 66 W/mK, chromium containing steels tend to have lower “k” values, with stainless steels as low as 17 W/mK. Chromium is often used to toughen tool steel for matched die applications, which provides significantly reduced quenching to the hot stamped steel, and work in the opposite direction of the present technology. Thermal conductivity is a strong driver for quench rate, and aluminum is much greater (3× to 7×) than typical stamping tool materials. Each of the stages is described in more detail below.

### Thermal Effusivity and Initial Contact Temperature

When two semi-infinite half-spaces, made from different materials, each at a different temperature, are brought together along an interface, the short term (often called instantaneous) interface temperature is controlled by the temperature of each material and the thermal effusivity “e” of each material through the relation:

$${T}_{m} = \frac{{e}_{1} {T}_{1} + {e}_{2} {T}_{2}}{{e}_{1} + {e}_{2}} ,$$

where T₁ and T₂ are the initial temperatures of the workpiece and die, respectively and e₁ and e₂ are the effusivities of the two materials (workpiece and die). This relation can be used to estimate the short-term interface temperature between a hot workpiece to be quenched, and a cool die material.

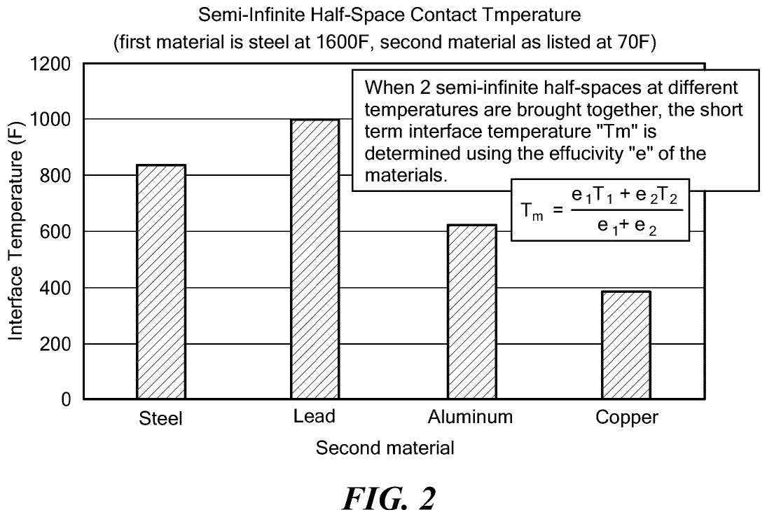

FIG. 2 lists interface temperatures for different die materials assuming a heated steel workpiece having an initial temperature of 1600 F and respective die materials having an initial temperature of 70 F. As shown, the aluminum 6061 die interface temperature is approximately 625F, much lower than the melting point of the proposed aluminum 6061 die materials, which is approximately 1080 F. It is thus the high effusivity of Aluminum that initially prevents the aluminum dies from melting in the presence of hot steel workpieces.

In addition, this lower interface temperature, in combination with the higher diffusivity discussed below, provides much more rapid removal of heat energy from the workpiece than conventional die materials such as steel, leading to a much faster quench rate for the workpiece.

An example of the outcome inventors expected from aluminum dies is shown with respect to lead. In particular, as shown in FIG. 2, a lead interface die temperature is approximately 997F, far above the 620 F melting point of lead. Thus, lead dies would melt on contact with the hot steel, damaging the die and disrupting contact between the dies and the workpiece.

Thermal Diffusivity and Transporting Heat Away from a Workpiece

Thermal diffusivity is a material property that indicates the ability to transport heat. In the case of a hot workpiece (e.g., steel at 1600 F) being quenched and/or formed in a cool die (e.g., aluminum at 70 F), diffusivity indicates the efficiency with which a die can move heat away from a hot workpiece, thus determining the workpiece temperature over a timespan of a few seconds to a few minutes.

As shown in Table 1 above, aluminum 6061 exhibits a diffusivity over 5 times that of the worst performer, steel 4340, indicating that it is far better at removing heat than a typical steel material. Thus, steel is unable to achieve the necessary quench rate to achieve desired properties in thicker workpieces (e.g., exceeding 0.125″ thick). Water cooling steel dies can be effective to speed up cooling by such steel dies, but the poor effusivity and diffusivity still produce a slower quench rate and, furthermore, cooling channels often result in uneven cooling when extracting the heat required for thicker workpiece materials. Titanium outperforms steel but remains at a significant disadvantage with respect to aluminum and copper.

Applicant notes that among candidate metal die materials having an interface temperature lower than their melting point, it is actually copper that exhibits the highest effusivity and diffusivity. However, copper is prone to sticking and/or bonding with any steel/iron workpieces, thus damaging the dies and/or the workpieces. Thus, as discussed below, Aluminum may, in some embodiments, be a preferred die material. Nevertheless, should the more rapid quench rate offered by copper be required for specific applications (e.g., for particularly thick workpieces or workpieces requiring particularly rapid cooling), an aluminum, diamond, or other coating on the copper dies may prevent such sticking and/or bonding.

### Thermal Mass (Heat Capacity) and Equilibrium Temperature

After contact for a few minutes, an equilibrium temperature “Tₑ” of a workpiece-die system is reached. Tₑ is governed by

$${T}_{e} = \frac{{T}_{1} {m}_{1} {C}_{P 1} + {T}_{2} {m}_{2} {C}_{P 2}}{{m}_{1} {C}_{P 1} + {m}_{2} {C}_{P 2}} ,$$

where T₁, m₁, and Cp₁ are the initial temperature, mass, and heat capacity at constant pressure respectively for the workpiece and T₂, m₂, and Cp₂ are the initial temperature, mass, and heat capacity at constant pressure respectively for the die.

Table 2 reports equilibrium temperatures for a 12″×12″ steel workpiece plate at 0.5″ thick and initial temperature of 1600 F, cooled in each case by two 12″×12″ aluminum die plates (one top and one bottom), each at an initial temperature of 70 F. Three cases are shown using varying thicknesses of aluminum die plates. In particular, the die plates each had a thickness of 0.5″ in case 1, 1.0″ in case 2, and 2.0″ in case 3.

TABLE 2

| | Case 1 | Case 2 | Case 3 |
|---|---|---|---|
| 2 Aluminum mold plates, thickness each (in) | 0.5 | 1.00 | 2.0 |
| Mold initial temperature (F.) | 70 | 70 | 70 |
| Mold mass, 12″ × 12″ (kg) | 6.5 | 13 | 26 |
| Mold heat capacity (J/kg-K) | 877 | 877 | 877 |
| Substrate initial temperature (F.) | 1600 | 1600 | 1600 |
| Substrate mass, ½″ steel, 12″ × 12″ (kg) | 10 | 10 | 10 |
| Substrate heat capacity (J/kg-K) | 417 | 417 | 417 |
| Equilibrium temperature (F.) | 716 | 480 | 307 |

As shown, the equilibrium temperature is strongly affected by the mass of the die. As such, where it is desirable to achieve and “hold” a particular temperature (e.g., for tempering operations), the mass and composition of the dies can be tuned to a specific workpiece mass and composition to achieve the proper hold temperature.

### Advantages of Aluminum Dies

As noted above, other die materials possess the high thermal properties (e.g., conductivity, effusivity, diffusivity, heat capacity) needed for rapid quench and the resulting high hardness properties of armor articles, including copper, which may be useful for particularly high speed quenching. However, experimentation has shown that aluminum may be a preferable option for several reasons, including that aluminum is durable, relatively inexpensive, easy to machine into die sets, and does not tend to stick, fuse, or otherwise bond to the workpiece. Further advantages of Aluminum include:

In some embodiments the use of bulk aluminum dies permits quenching of the steel in place at a rate high enough to produce a hard martensitic structure that can be effective against ballistic penetration but also be in a flat or contoured geometry without the threat of cracking or distortion. In particular, the thermal properties of aluminum are such that it drives a much more rapid quench compared to steel die materials yet the interface temperature on contact with hot steel (1600 F or so) is below the melting point, thus avoiding melt damage on contact.

In addition to steel processing applications, such aluminum dies can be used to quench age-hardened aluminum armor back to the un-aged temper so that the armor properties can be re-achieved via a subsequent aging process. Aluminum dies can also be used to readily form titanium armor materials at a temperature below that of the alpha/beta transition temperature which is a critical temperature where titanium alloys become compromised metallurgically.

Unlike copper, a high hardness coating of aluminum oxide (Al2O3) naturally occurs on the surface of aluminum tooling, which helps provide resistance to abrasion during the repeated contact and friction when quenching and/or forming steel plate. That is, due to the formation of the relatively hard aluminum oxide on the aluminum tooling and the formation of relatively soft iron oxide on the steel workpiece, the aluminum tooling is not significantly gouged or eroded by contact and friction with steel workpieces during quenching and/or forming, despite aluminum generally being softer than steel. In addition, this mechanism prevents sticking/bonding between the dies and the workpiece.

In addition, aluminum is relatively low cost and relatively easy to machine when compared with other candidate die materials. Furthermore, aluminum tooling is effective in several common alloys (e.g., 6061, 6101, 7075) as well as in other more specialized alloys, thereby mitigating potential supply shortages.

Aluminum's thermal expansion is twice that of alloys used for steel armor articles, facilitating maintenance of pressurized contact between the upper and lower dies and the workpiece. In particular, as the workpiece temperature decreases and the die temperature increases, the workpiece shrinks while the upper and lower dies expand, thus maintaining pressurized contact with the workpiece.

### Tunable Quench Kinetics

In some embodiments, the upper and lower dies may advantageously be provided with different initial temperatures and/or be constructed of different materials to drive different quench kinetics to different sides of the workpiece. Put another way, preferential or gradient quenching and tempering is possible using thermally controlled die sets.

Such techniques may be useful, for example, in instances where the workpiece is a multilayer bonded/laminated structure having different, and thus at least partially thermally mismatched, materials at the upper and lower surfaces thereof. Such techniques can also include instances wherein it is desirable to produce variable properties through the thickness of a single layer workpiece. Such applications can include, for example, dual hardness armor (DHA) steel, clad steel plate and/or diffusion bonded multilayer sheet material. In particular, clad steel and DHA steel are notoriously difficult to quench using liquid media without distortion or cracking/delamination. These difficulties result in prohibitive costs of production and very high scrap rates for any articles that are produced.

By contrast, the high controllability of the present technology, in combination with the mechanical dimensional/shape restraint of the workpiece by the dies during SSQ of the present technology reduce thermal distortion and internal stresses. These features are a particular advantage of the present technology in that they provide the present technology with the ability to reliably produce articles having such variable properties without risk of delamination, cracking, and/or degradation of those variable properties. This represents an enormous advancement and cost reduction in the production of such variable hardness steel articles, particularly whereas the production output is consistent and suffers much lower scrap rates than state-of-the-art technologies.

Furthermore, even if a small amount of warping due to springback or residual stresses is unavoidable with such materials, the dies can be shaped or cut and their temperatures progressively adjusted in real time to compensate for that distortion and/or stress, thus still producing the workpiece in its proper shape, without damage, after removal from the press.

In some embodiments, instead of or in addition to varying the bulk material of the die or dies, the die or dies can be layered or coated with different materials. For example, in some embodiments a workpiece contact layer or coating could be relatively thin and drive a particular instantaneous interface temperature based on its thermal effusivity, while another material can be used as the bulk of the die material to govern the intermediate time quench kinetics based on its diffusivity. In this way the quench process can be tailored to provide kinetics that are not possible with a single die material.

### Exemplary SSQ for Quench Hardening of Steel Armor

With respect to steel armor, steel alloys and other traditional armor alloys, as well as abrasion resisting alloys and other applications requiring high hardness, can be processed via SSQ at any size, thickness, and composition so long as the die sets are sized and configured to extract heat faster than a critical quench rate for forming martensite in the workpiece. The process is also effective with multi-layer steels such as roll bonded or clad steels where each layer has unique properties as related to ballistics or other end uses.

In some embodiments, an exemplary SSQ process for quench hardening armor steel sheets/plates can be as follows:

Incoming raw material in plate or sheet is produced by a steel mill to the appropriate chemistry for conversion to armor.

The flat plates/sheets are either cut to a near net shape or retained in a rectangular form and heated in a furnace above a critical temperature called the austenitizing temperature, which is typically above 1400 F. The steel is held at the austenitizing temperature for a prescribed time, typically a time required for the entire steel workpiece to reach an equilibrium state where all of the steel is converted to have an austenite crystal structure.

Once the sheets/plates are heated, they are placed in either flat or contoured die sets made from aluminum and the dies are closed. The heat from the steel is extracted by the dies at a rapid enough rate for the steel to change from austenite to martensite. If the dies are contoured, the workpiece can then take on the necessary shape without distortion because it is constrained in the die set.

In some embodiments, the quenched metal workpiece may come out of the die with the appropriate hardness and ballistic properties without a need for further processing, resulting in a final metal article once fully cooled. In some embodiments, the quenched metal workpiece may require subsequent processing such as tempering (e.g., by heating to temperatures below 500 F (typically used for higher hardness armors) or over 800 F (typically used for blast steels)) to fine tune a balance between hardness and toughness in a controlled manner to achieve desired properties of the final metal article. The hotter and longer the temper, the softer and tougher the material gets. Most armor requires a delicate balance between hardness and toughness and this is outlined in various military specifications for armor steels.

As noted above, in addition to purely solid state quenching, the dies could also be heated or cooled even more rapidly via liquid cooling channels. This permits heat-treatments more complex than simple quenching from austenite to martensite. Such treatments can be useful for specialty armor materials for armor or other high strength and toughness applications.

One application for SSQ processing can include metallic sheet-like (or “plate-like” for heavier thickness flat products) (“Armor Articles”). Such armor articles can include armor chest plates, vehicle armor plates, ballistic shields, or any multipurpose armor plate used to protect from ballistic threats including projectiles (e.g., bullets) and blast debris (e.g., fragmentary debris such as shrapnel). Requirements for such applications are specified, for example, in MIL_DTL_46186B and/or MIL-DTL-32332A.

As used herein, characterizing an article as meeting MIL_DTL_46186B, MIL-DTL-32332A, MIL-A-46099C, MIL-DTL-46100, and/or any other military armor specification means that it at least meets the ballistic requirements, and may or may not meet the other requirements in the specification. Experimental armor steels produced by SSQ have consistently been able to meet MIL DTL_46186B and/or MIL-DTL-32332A requirements. Such armor steels have exhibited the following properties:

For Grade 650 under MIL-DTL-32332A Class 2, solid state quenched steel plate has been consistently produced having a thickness of 0.220 inches or greater, including thicknesses of 0.25 inches, hardness of at least 650 Brinell (Grade 650 under MIL-DTL-32332A Class 2), an ultimate tensile strength greater than 340 ksi, a yield strength greater than 210 ksi, and an elongation greater than 9%.

For Grade 550 under MIL-DTL-46186B Class 2, solid state quenched steel plate has been consistently produced having a thickness of 0.220 inches or greater, including thicknesses of 0.25 inches, hardness of at least 550 Brinell (Grade 550 under MIL-DTL-46186B Class 2), an ultimate tensile strength greater than 290 ksi, a yield strength greater than 190 ksi, and an elongation greater than 10%.

Table 3 lists experimental testing results for two samples of Grade 650 armor steel produced by SSQ. Each meets MIL-DTL-32332A Class 2 requirements:

TABLE 3

| UTS | 0.2% YS | Elong | RA | Modulus |
|---|---|---|---|---|
| ksi\MPa | ksi\MPa | % | % | Msi\GPa |
| 344.0\2370 | 215.1\1480 | 11 | 40 | 29.6\204 |
| 343.6\2370 | 214.0\1480 | 9.5 | 34 | 31.7\219 |

Table 4 lists experimental testing results for two samples of Grade 550 armor steel produced by SSQ. Each meets MIL-DTL-46186B Class 2 requirements:

TABLE 4

| UTS | 0.2% YS | Elong | RA | Modulus |
|---|---|---|---|---|
| ksi\MPa | ksi\MPa | % | % | Msi\GPa |
| 297.6\2050 | 196.9\1360 | 11 | 44 | 29.2\201 |
| 298.1\2060 | 207.3\1430 | 11 | 38 | 28.8\199 |

SSQ is also suitable for the production of more complex armor articles including, for example, dual hardness materials as set forth in MIL-A-46099C, MIL-DTL-46100. Furthermore, as noted above, other, non-armor applications, including high hardness, high wear, high abrasion, and/or other industrial or commercial applications may also benefit from SSQ processing. As such, as used herein, characterizing an article as meeting a material specification means that it at least meets the metallurgical performance requirements of the cited specification.

Formed curvatures with Radius/Thickness ratios less than 16 (and even as low as 1.0) are possible while maintain hardness in the 550 to 650 Brinell range and meet specifications MIL DTL 46186B and/or MIL-DTL-32332, for armor grade steel.

the thicker thermally conductive dies (Aluminum) have enough thermal mass to even out the cooling on curved parts. Automotive press stamping in cooled steel dies often results in challenges with retained austenite in curved areas with these water cooled tool steel dies since making the coolant do the work is less effective in curved or constrained areas.

### Advantages of SSQ:

Because fluid quenchants are not used in connection with SSQ, all of the above-cited disadvantages of using fluid quenchants are eliminated, including hydrogen embrittlement, crack fracture sensitivity, environmentally induced cracking, non-uniform quenching caused by self-insulating boiling regions and the like, corrosion, and scaling. When it comes to environmentally assisted cracking, hydrogen cracking is a concern in the context of armor steel. Hydrogen embrittlement occurs when atomic hydrogen is absorbed by the steel, leading to reduced ductility and increased susceptibility to cracking. This can be especially critical in environments where hydrogen is present, such as during certain manufacturing processes or in service conditions. Water quenching in particular, can introduce water into microcracks on the edges or surface that, without such intrusion, may or may not be removed in subsequent tempering or other processes. However, if microscopic amounts of water (hydrogen) intrude into such microcracks or welds, further cracking can occur, sometimes immediately and sometimes much later during downstream processing, at which point the crack are so large and/or the article is so far downstream that crack remediation is no longer possible. By reducing and/or eliminating the amount of water touching the steel, this issue is mitigated. In addition, because no oil quenchants are used, SSQ limits negative environmental impacts, improves employee health and safety, and eliminates the need for cleaning oil from the article.

Hydrogen embrittlement can also be caused by welding operations, wherein free hydrogen is introduced during welding from the weld wire or the process or from the air. By heat-treating the welded workpiece and then quenching using SSQ, such free hydrogen can be reduced in the workpiece, thereby mitigating or eliminating weld-induced hydrogen embrittlement.

Thus, some of the benefits of the present technology include maintaining high hardness and toughness of the produced metal article, tooling is easier and less expensive to create and operate, the SSQ process is effective for healing weldments, thermal cuts, and multilayer structures as well as for quenching, tempering, and treating one-piece components, and producing highly curved stamped geometries while maintaining hardness in the range of 550 to 650 Brinell. Furthermore, unlike conventional stamping and forming, which typically indicates drawing the steel, leading to thinning, the SSQ stamping or forming substantially functions more like curving and contouring in a molded die set and is thus more dimensionally stable.

### Hybrid Solid State and Fluid Quench

In some instances, heated metal workpieces can include complex geometric features, particularly out-of-plane geometric features, which are not conducive to purely solid-state quenching. For example, such complex features may be difficult to bring into contact with the upper and lower (or any other) dies. Thus, such out-of-plane features can be inadequately quenched which can lead to a variety of unwanted outcomes including, for example, lower strength in the non-contact areas, greater local and overall thermal distortion of the workpiece due to non-uniform thermal expansion/contraction, and high residual stress, among others. In addition, even where contact with such features is possible, maintaining such contact is likely to prove even more difficult, if not impossible, when thermal expansion and contraction of the workpiece and the dies is considered.

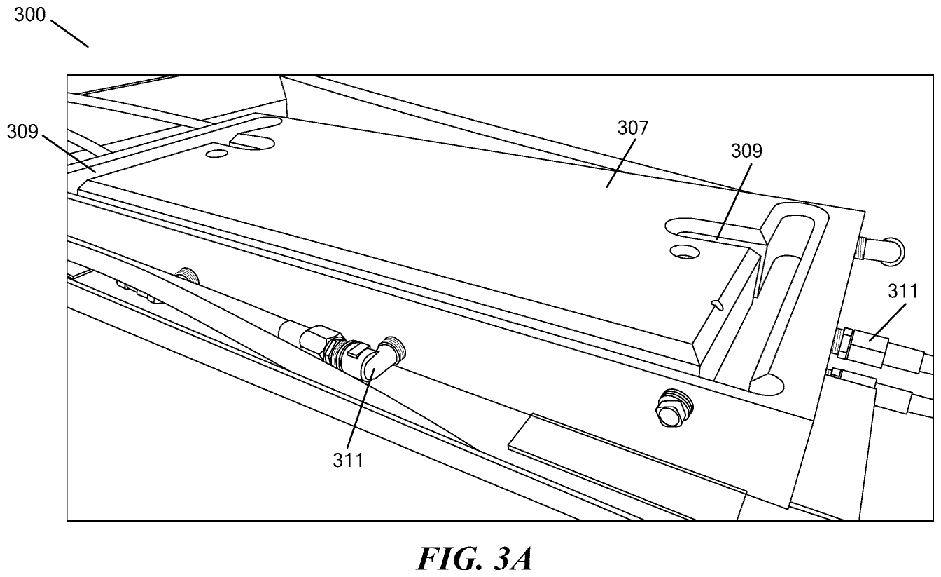

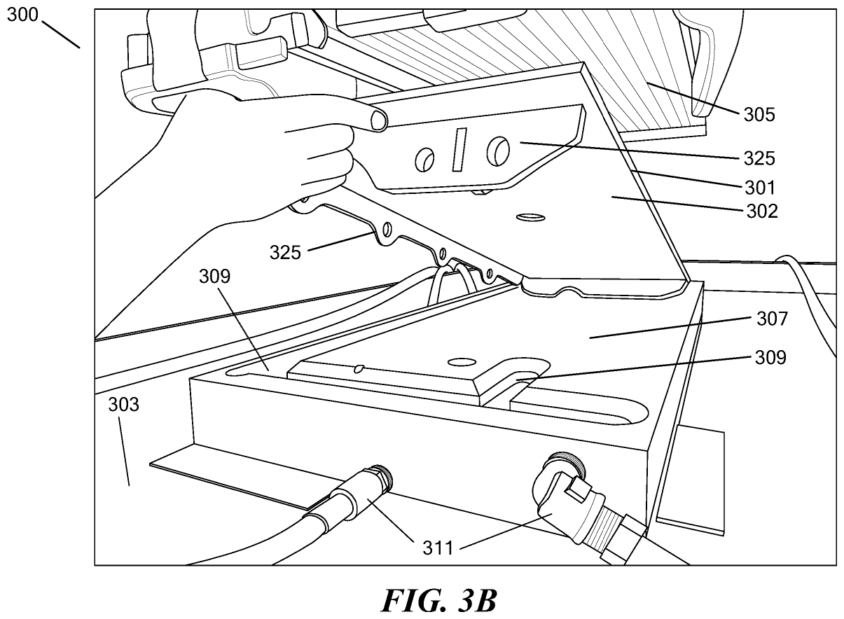

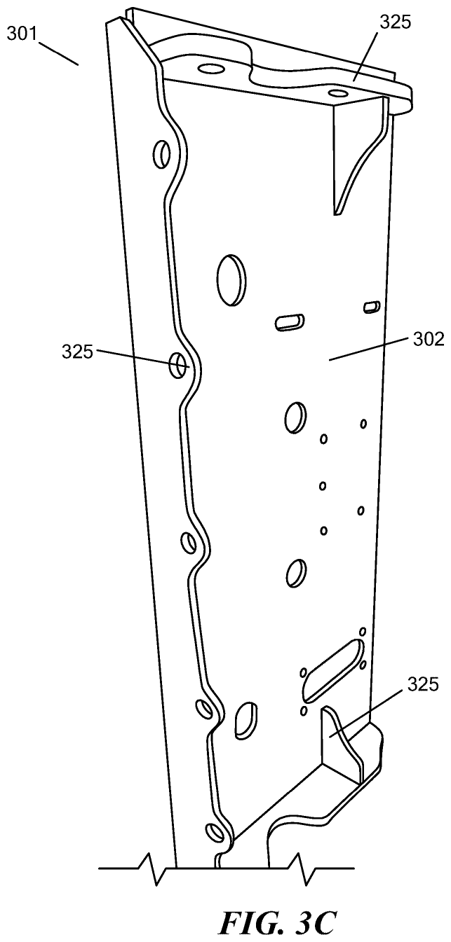

Accordingly, in such cases, a hybrid solid state and fluid quench (HSSQ) can be used. As shown in FIGS. 3A-3C, in such processes an HSSQ 300 can include a press 303 having an upper die 305 and a lower die 307 for being brought in to pressurized contact with a metal workpiece 301 having a primary substrate 302 and at least one out of plane feature 325. At least one of the upper and lower dies 305, 307 includes one or more voids 309, preferably conforming to a shape of the at least one out of plane feature 325. The press 303 can also include one or more plumbing features 311 for pumping fluid quenchants such as water, oil, salt water, molten salts, molten metals, glycol, dielectric fluids, any other suitable fluid quenchants, or combinations thereof as well as, for example, such fluid quenchants mixed with particulates including, for example, copper dust, silicon carbide particles, aluminum powder, any other suitable particulates, or combinations thereof. The plumbing features 311 are configured to pump the fluid quenchant into the voids 309 for cooling and quenching the out of plane features 325 of the workpiece 301. In some embodiments, the plumbing 311 can be designed so as to direct coolant at specific areas on the primary substrate 302, the out of plane features 325, the upper and/or lower dies 305, 307, in the voids 309, or combinations thereof. The plumbing 311 can also include a means for the fluid quenchant to escape and/or be evacuated (e.g., by suction), thus advantageously creating flow through the voids 309, further improving the fluid quench.

In some embodiments, in use, the HSSQ 300, can follow a similar process to the SSQ process described above with respect to the solid state aspects of the HSSQ. First, the heated metal workpiece 301 having an initial workpiece temperature is transferred to the press 303, with the out of plane features 325 aligned and/or placed in the corresponding voids 309. Then, the press 303 is closed, bringing the heated metal workpiece 301 into pressurized contact with the upper and lower dies 305, 307. Either while the press 303 is closing or immediately after pressurized contact is made between the workpiece 301 and the upper and lower dies 305, 307, the plumbing 311 begins to flow the fluid quenchant through the voids 309 in order to provide simultaneous solid state quenching of the workpiece 301 in the areas (e.g. the primary substrate 302) of pressurized contact with the upper and lower dies 305, 307 and fluid quenching of other areas of the workpiece 301 (e.g., the out of plane features 325 within the voids 309 and proximate portions of the primary substrate 302).

The pressurized contact between the upper and lower dies 305, 307 and the workpiece 301, as well as the flow of the fluid quenchant via the plumbing 311 is maintained for a time sufficient to cool the workpiece 301 to a desired temperature, at which point the fluid flow is stopped, the press 303 is opened, and the workpiece 301 is removed from the press 303.

In accordance with various embodiments, the metal workpiece 301 can include a primary substrate 302 of any size, shape, or thickness and include any number of out of plane features 325, each of any size, shape, or thickness. As used herein, “out of plane” features 325 refers to any feature of the workpiece 301 that protrudes from (e.g., is not locally parallel to and/or generally part of the primary substrate 302). For example, but without limitation, such features may include flanges, fins, pins, beams, stringers, vanes, rotor blades, any other out of plane features, or combinations thereof.

The primary substrate 302 of the metal workpiece 301 can be flat, contoured, complex contoured, domed, a hollow cylinder, chest plate shaped, vehicle panel shaped, bent (e.g., in some embodiments having a bend radius to thickness ratio of less than 5:1, including less than 2:1, or even equal to 1:1. In addition, the primary substrate can be constructed of any suitable metal including, for example, iron, steel, aluminum, titanium, copper, nickel tungsten, any other suitable metal that would benefit from shape-controlled cooling and/or rapid quenching to produce preferred microstructures, as well as alloys and/or combinations thereof. It will be apparent in view of this disclosure that any thickness of steel or other metal material (e.g., thicknesses equal to or exceeding 0.01″, including about 0.01″, 0.1″, 0.25″, 0.5″, 1″, 1.25″, 1.5″, 1.75″, 2″ or more), or even primary substrates 302 comprising multiple such layers of metal material, can be quenched using the HSSQ processes described herein. For example, in some embodiments, HSSQ 300 can be performed on a metal workpiece 301 having a primary substrate 302 comprising a 0.25″ steel plate.

As noted above, “out of plane” features 325 refers to any feature of the workpiece 301 that protrudes from (e.g., is not locally parallel to and/or generally part of the primary substrate 302). For example, but without limitation, such features may include flanges, fins, pins, beams, stringers, vanes, rotor blades, any other out of plane features, or combinations thereof. The out of plane features 325 can be constructed of any suitable metal including, for example, iron, steel, aluminum, titanium, copper, nickel tungsten, any other suitable metal that would benefit from shape-controlled cooling and/or rapid quenching to produce preferred microstructures, as well as alloys and/or combinations thereof. It will be apparent in view of this disclosure that such out of plane features 325 can have any thickness of steel or other metal material (e.g., thicknesses equal to or exceeding 0.01″, including about 0.01″, 0.1″, 0.25″, 0.5″, 1″, 1.25″, 1.5″, 1.75″, 2″ or more), or even comprise multiple such layers of metal material. In addition, the out of plane features can take any suitable shape including, for example, flat, contoured, complex contoured, domed, a hollow cylinder, chest plate shaped, vehicle panel shaped, bent (e.g., in some embodiments having a bend radius to thickness ratio of less than 5:1, including less than 2:1, or even equal to 1:1. For example, as shown in FIGS. 3A-3C, HSSQ 300 can be performed on a metal workpiece 301 having a primary substrate 302 comprising a 0.25″ steel plate and out of plane features 325 comprising one or more flanges.

In some embodiments, in addition to performing direct SSQ of the workpiece 301 areas (e.g. the primary substrate 302) in pressurized contact with the upper and lower dies 305, 307, the upper and lower dies 305, 307 are configured to conduct sufficient heat away from the fluid flowing through the void to prevent the fluid from undergoing a phase change in the one or more voids 309. For example, the thermal properties of the upper and/or lower dies 305, 307 in which the voids 309 are formed, the thermal properties of the fluid quenchant, the volume of the voids 309, and the mass flow rate of the fluid quenchant, should be selected such that, during HSSQ processing of the workpiece, the fluid is able to convect heat from the metal workpiece to the first and second dies without undergoing a phase transformation (e.g., boiling) in the one or more voids 309. Such features advantageously prevent many issues with conventional fluid quenching, including, for example, the development of turbulent boundary layers which, as noted above, block new cooling flow by trapping heat and can create real time warping due to uneven cooling, further restricting or otherwise negatively affecting fluid flowpaths.

This is made possible by two mechanisms. First, rather than merely removing and then absorbing heat from the workpiece 301 as in conventional fluid quenching processes, the fluid quenchant of the instant application is removing the heat from the workpiece 301 and also transferring (convecting) that heat to the highly thermally conductive dies 305, 307, thereby keeping the fluid quenchant at a comparatively low temperature. Second, even in the HSSQ process, a significant portion of the workpiece 301 is being quenched via the SSQ mechanisms described above, namely, direct pressurized contact with the upper and lower dies 305, 307. In that regard, it will be apparent in view of this disclosure that, in various embodiments, HSSQ is possible using dies 305, 307 having any ratio of contact area to void area. For example, HSSQ can be performed in instances wherein the dies 305, 307 are in pressurized contact with 99% or more of a surface area of the primary substrate 302 and the fluid quenchant, via the voids, contacts only 1% or less of the surface area of the primary substrate 301. Alternatively, in some instances, the dies 305, 307 can be in pressurized contact with only 1% or less of the surface area of the primary substrate 302 and the fluid quenchant, via the voids, contacts 99% or more of the surface area of the primary substrate 302. However, in accordance with various embodiments, in order to obtain the mechanical restraint benefits of the SSQ aspect of the HSSQ process, the dies 305, 307 can preferably be in pressurized contact with at least 25% of the surface area of the primary substrate 302 and more preferably, the dies 305, 307 can preferably be in pressurized contact with at least 50% of the surface area of the primary substrate 302.

### Advantages of HSSQ

In addition to all of the advantages mentioned above with respect to SSQ, by employing HSSQ, highly complex geometries can be successfully quenched without imparting undue internal stresses or causing inadvertent distortion or cracking. In addition, by using materials having high thermal conductivity for the dies and flowing the fluid quenchant such that the dies cool the fluid as well as the workpiece, heat transfer can be accomplished in seconds and in a highly repeatable manner. This technique thus permits processing of much more complex workpiece shapes while realizing, enormous cost savings, increases in material throughput, and decreases in scrap rate as compared with the prior art.

The ability to successfully quench and temper such complex workpiece shapes adds further benefits because it opens the door to forming, bending press braking, welding, laser or plasma cutting, etc. untreated metal (e.g., “green” metal) to form a desired final article geometry before any heat-treatment. Accordingly, any heat affected zones, heat affected edges, microcracking, internal stresses, and/or other negative impacts from such processes can be corrected or “healed” during the subsequent heating, HSSQ process, and any other post-processing. Furthermore, unquenched, untempered workpiece material is commonly much more ductile and workable than, for example, solution hardened metal articles, reducing the need for expensive tooling and processes for handling such articles post-quenching and tempering.

### Protrusion Alignment Features for Press Brake Forming of Steel

With respect to forming of steel (e.g., prior to HSSQ or SSQ processing), one common means for bending or otherwise forming the green steel is brake pressing. As part of such operations, particularly when forming large and/or thick workpieces, it is common to laser cut indicator/alignment features to mark the sheets/plates where the bends are to be made by the press brake.

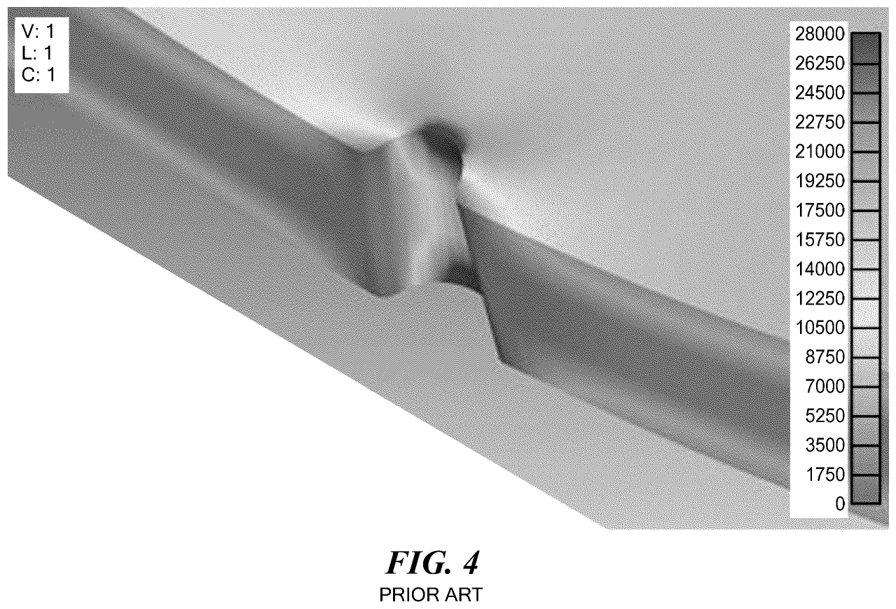

The chemistry of the green steel is ideally suited to become martensite if very high cooling rates can be achieved. In the case of laser cutting, the material at the laser cut edge is fully melted, but only in a very small heat affected edge zone. Therefore, the proportionally much larger mass of the steel that is thermally unaffected by the laser beam conducts heat away from the heat affected edge quickly enough to create un-tempered Martensite right at the part edge. When using common laser cut features to mark the plates where bends will be made, the effect of this untempered martensite can either be amplified or negated by the correct voice of geometry. Conventionally, such features take the form of cutouts or grooves along the edge in an out of plane direction as shown in FIG. 4. However, as shown, such features greatly amplify stress and can cause cracking, even in the green steel. Such cracks can then propogate during subsequent processing, potentially causing irreversible damage, including breakage and/or a failure to meet specifications after extensive, expensive downstream processing.

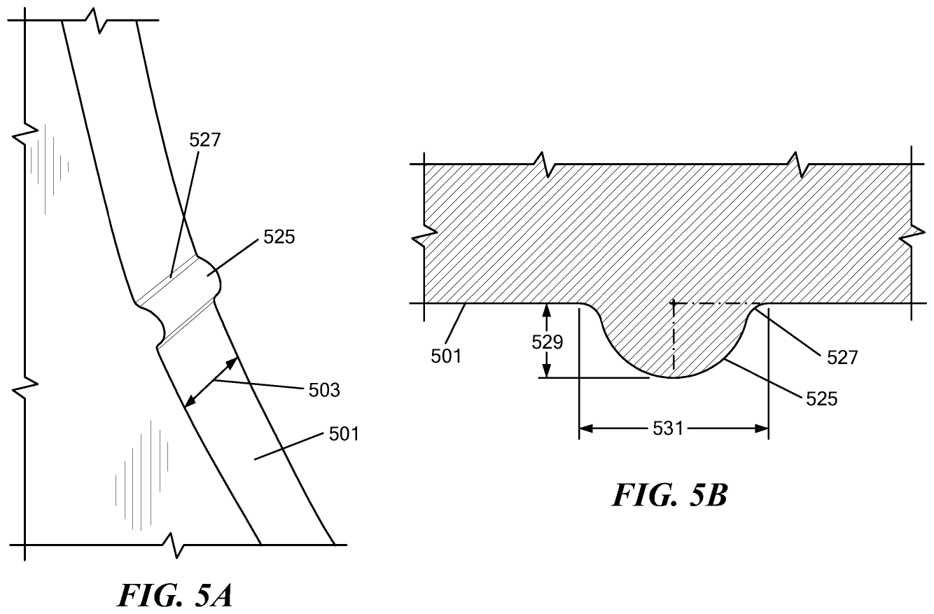

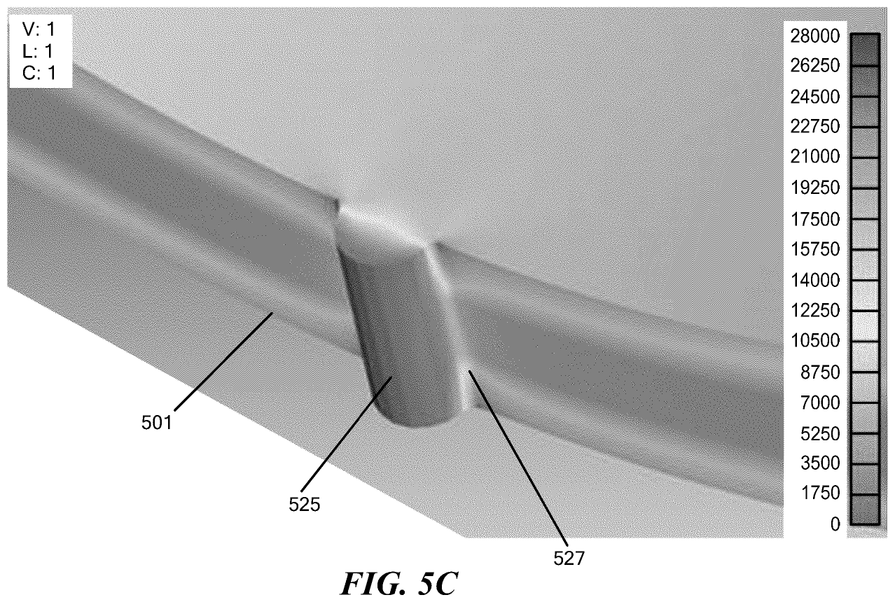

As shown in FIGS. 5A-5C, the present technology provides a protruding indicator 525 along a workpiece edge 501 and including filleted transitions 527 between the indicator 525 and the workpiece edge 501. As shown in FIG. 5C, opposite to the stress concentration caused by conventional cutout or groove features, the protruding indicator 525 reduces stresses at the bend line during brake pressing, preventing edge cracking and downstream complications.

The protruding indicator 525 can be any desired size and shape according to specific requirements. However, in order to reduce stresses and prevent cracking, the protruding indicator 525 can preferably include a rounded (e.g., circular and/or elliptical) cross-section and can preferably have a width 531 equal to at least about 50% or more of a thickness 503 of the workpiece edge 501 and a height 529 extending outward from the edge 501 at least about 33% or more of the thickness 503 of the workpiece edge 501. The protruding indicator 525 can also preferably extend from the workpiece edge 501 along the entire thickness 503 thereof.

The filleted transitions 527 can generally be provided with any suitable radius. However, in order to reduce stresses and prevent cracking, the filleted transitions 527 can preferably have a fillet radius equal to at least about 8% or more of the thickness 503 of the workpiece edge 501.

### Exemplary Protruding Indicator

For example, the experimental workpiece 501 shown and illustrated in FIGS. 5A-5B and having the bending-induced stress characteristics shown in FIG. 5C had a thickness 503 of about 0.250″ and was provided with an experimental protruding indicator 525. The experimental protruding indicator 525 included a width 531 of about 0.155″, a height 529 of about 0.090″, an exterior radius of about 0.060″, and filleted transitions 527 having a fillet radius of about 0.020″.

While example embodiments have been particularly shown and described, it will be understood by those skilled in the art that various changes in form and details may be made therein without departing from the scope of the embodiments encompassed or contemplated herein.

As used herein, “consisting essentially of” allows the inclusion of materials or steps that do not materially affect the basic and novel characteristics of the claim. Any recitation herein of the term “comprising”, particularly in a description of components of a composition 5 or in a description of elements of a device, can be exchanged with “consisting essentially of” or “consisting of”.

What is claimed is:

1. A method for solid state quenching of metal comprising:
transferring a heated metal workpiece having an initial workpiece temperature to a press, the press comprising:
a first die having an initial first die temperature, the initial first die temperature being lower than the initial workpiece temperature, and
a second die positioned opposite the first die and having an initial second die temperature, the initial second die temperature being lower than the initial workpiece temperature,
wherein the first and second dies are each constructed of a material having a thermal conductivity equal to or greater than 90 W/mK at a temperature of 70 F;
closing the press to bring the first die and the second die into pressurized contact with the heated metal workpiece;
continuing the pressurized contact between the first and second dies and the metal workpiece to cool the metal workpiece from the initial workpiece temperature to a quenched workpiece temperature;
opening the press when the metal workpiece reaches the quenched workpiece temperature to produce a quenched metal workpiece; and
removing the quenched metal workpiece from the press.

2. The method of claim 1, further comprising cooling the quenched metal workpiece to a fully cooled temperature to produce a metal article.

3. The method of claim 2, further comprising reheating the metal article to a tempering temperature greater than the fully cooled temperature and less than the initial workpiece temperature.

4. The method of claim 3, further comprising:
maintaining the metal article at the tempering temperature for a predetermined time; and
recooling the metal article to the fully cooled temperature to produce a tempered metal article.

5. The method of claim 1, further comprising:
maintaining the quenched metal workpiece at the quenched workpiece temperature for a predetermined time; and
cooling the quenched metal workpiece to a fully cooled workpiece temperature to produce a metal article.

6. The method of claim 2, wherein the step of cooling the quenched metal workpiece to a fully cooled temperature to produce a metal article further comprises autotempering the quenched metal workpiece in an ambient environment.

7. The method of claim 1, wherein the quenched workpiece temperature is equal to a fully cooled temperature and the quenched metal workpiece is a metal article.

8. The method of claim 2, further comprising laser cutting the metal article to produce at least one cut edge in the metal article.

9. The method of claim 8, further comprising:
reheating the metal article to a heat-treating temperature equal to or greater than the fully cooled temperature and less than the initial workpiece temperature;
maintaining the metal article at the heat-treating temperature for a predetermined time sufficient to recrystallize at least one unwanted crystalline structure formed along the cut edge during the step of laser cutting; and
recooling the metal article to the fully cooled temperature to produce a healed metal article.

10. The method of claim 9, further comprising:
transferring the reheated metal workpiece to the press; and
reclosing the press to bring the first die and the second die into pressurized contact with the reheated metal article.

11. The method of claim 2, further comprising:
creating a heat affected zone (HAZ) of the metal article by welding the metal article;
reheating the metal article to a HAZ heat-treating temperature greater than the fully cooled temperature and less than the initial workpiece temperature;
maintaining the metal article at the heat-treating temperature for a predetermined time sufficient to recrystallize at least one unwanted crystalline structure of the HAZ; and
recooling the metal article to the fully cooled temperature to produce a healed metal article.

12. The method of claim 11, further comprising:
transferring the reheated metal workpiece to the press; and
reclosing the press to bring the first die and the second die into pressurized contact with the reheated metal article.

13. The method of claim 1, wherein the metal workpiece includes one or more of iron, steel, aluminum, titanium, copper, nickel tungsten, alloys thereof, and combinations thereof.

14. The method of claim 1, wherein the first and second dies are constructed of a material having higher thermal conductivity, effusivity, and diffusivity than the metal workpiece.

15. The method of claim 1, wherein the first and second dies are constructed of at least one of aluminum or an aluminum alloy.

16. The method of claim 1, wherein a shape of the heated metal workpiece is at least one of flat or three-dimensional.

17. The method of claim 16, wherein the first and second dies are flat for producing a flat quenched metal workpiece.

18. The method of claim 17, wherein the quenched metal workpiece is a sheet or plate.

19. The method of claim 17, wherein the shape of the heated metal workpiece is flat and the flat shape of the first and/or second dies is complementary to the flat shape of the heated metal workpiece.

20. The method of claim 17, wherein the shape of the heated metal workpiece is three-dimensional and the pressurized contact between the flat first and second dies and the heated metal workpiece forms the heated metal workpiece into the flat quenched metal workpiece.

21. The method of claim 16, wherein at least one of the first and second dies has a three-dimensional mold shape for producing a three-dimensionally shaped quenched metal workpiece.

22. The method of claim 21, wherein the shape of the heated metal workpiece is three-dimensional and the three-dimensional mold shape of the first and/or second dies is complementary to the three-dimensional shape of the heated metal workpiece.

23. The method of claim 21, wherein the three-dimensional mold shape of the first and/or second dies is different than the shape of the heated metal workpiece and the pressurized contact between the first and second dies and the heated metal workpiece forms the heated metal workpiece into the three-dimensionally shaped quenched metal workpiece.

24. The method of claim 16, wherein the shape of the heated metal workpiece is three-dimensional, the method further comprising:
forming a metal workpiece to provide a shaped metal workpiece; and
heating the shaped metal workpiece to produce the heated metal workpiece.

25. The method of claim 24, wherein the step of forming further comprises at least one of sheet metal braking, die forming, progressive die forming, welding, cutting, machining, 3D printing, or combinations thereof.

26. The method of claim 25, wherein the step of heating further comprises heat-treating the metal workpiece.

27. The method of claim 26, wherein the step of forming includes at least one of laser cutting, welding, or both and the step of heat-treating includes at least one of:
maintaining the shaped metal workpiece at a HAZ heat-treating temperature for a predetermined time sufficient to recrystallize at least one unwanted crystalline structure of a heat affected zone (HAZ) created in the shaped metal workpiece by the welding; or
maintaining the shaped metal workpiece at a cut edge heat-treating temperature for a predetermined time sufficient to recrystallize at least one unwanted crystalline structure formed along a cut edge of the shaped metal workpiece during the step of laser cutting.

28. The method of claim 1, further comprising cooling at least one of the first die or the second die.

29. The method of claim 28, wherein the step of cooling at least one of the first die or the second die is performed by a liquid cooling system of the press, wherein a liquid coolant of the liquid cooling system does not contact the workpiece.

30. The method of claim 1, further comprising heating at least one of the first die or the second die.

31. The method of claim 30, wherein the step of heating at least one of the first die or the second die is performed by one or more of:
at least one electrical element of the press, wherein the at least one electrical element does not contact the workpiece; or
a liquid heating system of the press, wherein a liquid of the liquid heating system does not contact the workpiece.

32. The method of claim 1, wherein the step of closing the press further comprises bringing at least one additional die of the press into pressurized contact with the heated metal workpiece.

33. The method of claim 1, wherein the initial workpiece temperature exceeds a melting point of at least one of the first die or the second die.

34. The method of claim 1, wherein the step of continuing the pressurized contact between the first and second dies and the metal workpiece includes continuing the pressurized contact at a pressure equal to or greater than 1 psi.

35. A method for hybrid quenching of metal comprising:
transferring a heated metal workpiece having a primary substrate, one or more out of plane features, and an initial workpiece temperature to a press, the press comprising:
a first die having an initial first die temperature, the initial first die temperature being lower than the initial workpiece temperature,
a second die positioned opposite the first die and having an initial second die temperature, the initial second die temperature being lower than the initial workpiece temperature, and
one or more voids defined in the first die, the second die, or both, at least one of the one or more voids corresponding to and sized to receive one of the out of plane features of the heated metal workpiece,
wherein the first and second dies are each constructed of a material having a thermal conductivity equal to or greater than 90 W/mK at a temperature of 70 F;
closing the press to bring the first die and the second die into pressurized contact with at least 50% of a surface area of the primary substrate of the heated metal workpiece;
flowing a fluid through the one or more voids to flow over the corresponding one of the out of plane features of the heated workpiece received therein;
continuing both the fluid flow through the one or more voids and the pressurized contact between the first and second dies and the primary substrate to cool the metal workpiece from the initial workpiece temperature to a quenched workpiece temperature;
terminating the fluid flow and opening the press when the metal workpiece reaches the quenched workpiece temperature to produce a quenched metal workpiece; and
removing the quenched metal workpiece from the press.

36. The method of claim 35, wherein the fluid is at least one of water, oil, salt water, a molten salt, a molten metal, glycol, a dielectric fluid, or combinations thereof.

37. The method of claim 35, wherein the press further comprises a fluid input port and a fluid output port to permit flowing of the fluid through the one or more voids.

38. The method of claim 35, wherein the first and second dies are configured to conduct heat away from both the metal workpiece and the flowing fluid.

39. The method of claim 38, wherein the first and second dies are constructed of a material having higher thermal conductivity, effusivity, and diffusivity than the metal workpiece.

40. The method of claim 38, wherein the first and second dies are configured to conduct sufficient heat away from the flowing fluid to prevent the flowing fluid from undergoing a phase change in the one or more voids.

41. The method of claim 38, wherein a mass flow rate of the flowing fluid permits the flowing fluid to convect heat from the metal workpiece to the first and second dies without undergoing a phase transformation in the one or more voids.

42. The method of claim 35, further comprising cooling the quenched metal workpiece to a fully cooled temperature to produce a metal article.

43. The method of claim 42, further comprising laser cutting the metal article to produce at least one cut edge in the metal article.

44. The method of claim 43, further comprising:
reheating the metal article to a heat-treating temperature equal to or greater than the fully cooled temperature and less than the initial workpiece temperature;
maintaining the metal article at the heat-treating temperature for a predetermined time sufficient to recrystallize at least one unwanted crystalline structure formed along the cut edge during the step of laser cutting; and
recooling the metal article to the fully cooled temperature to produce a healed metal article.

45. The method of claim 44, further comprising:
transferring the reheated metal workpiece to the press;
reclosing the press to bring the first die and the second die into pressurized contact with the reheated metal article; and
flowing the fluid through the one or more voids to flow over the corresponding one of the out of plane features of the reheated workpiece received therein.

46. The method of claim 42, further comprising:
creating a heat affected zone (HAZ) of the metal article by welding the metal article;
reheating the metal article to a HAZ heat-treating temperature greater than the fully cooled temperature and less than the initial workpiece temperature;
maintaining the metal article at the heat-treating temperature for a predetermined time sufficient to recrystallize at least one unwanted crystalline structure of the HAZ; and
recooling the metal article to the fully cooled temperature to produce a healed metal article.

47. The method of claim 46, further comprising:
transferring the reheated metal workpiece to the press;
reclosing the press to bring the first die and the second die into pressurized contact with the primary substrate of the reheated metal article; and
flowing the fluid through the one or more voids to flow over the corresponding one of the out of plane features of the reheated workpiece received therein.

48. A method for bending metal by press braking comprising:
laser cutting a metal plate to form a protrusion alignment feature thereon at a location to be bent, the protrusion alignment feature including:
a rounded protrusion extending outward from an edge of the metal plate and oriented along the edge in an out of plane direction relative to the metal plate, and
first and second filleted transitions positioned along opposing sides of the rounded protrusion between the rounded protrusion and the metal plate; and
bending, using a press brake, the metal plate at a location indicated by the protrusion alignment feature.
